(19) United States
(12) Patent Application Publication
(10) Pub. No.: US 2025/0217626 A1
(43) Pub. Date: Jul. 3, 2025

(54) Generating Content via a Machine-Learned Model Based on Source Content Selected by a User

(71) Applicant: Google LLC, Mountain View, CA (US)

(72) Inventors: Raiza Martin, Fremont, CA (US); Adam Joshua Bignell, Mountain View, CA (US); Oliver Michael King, Mountain View, CA (US); Wesley Carrington Hutchins, Santa Clara, CA (US); Piyush Sharma, Sunnyvale, CA (US); Jason Samuel Spielman, Los Altos, CA (US); Steven Johnson, Brooklyn, NY (US); Darryl James Murray, San Jose, CA (US); Stephen Hughes, Santa Clara, CA (US); Timothy Michael Gleason, Jersey City, NJ (US)

(21) Appl. No.: 18/397,766

(22) Filed: Dec. 27, 2023

(51) Int. Cl. G06N 3/0455; G06N 3/08

(52) U.S. Cl. CPC G06N 3/0455; G06N 3/08

(57) ABSTRACT

A computing device for generating content includes one or more memories to store instructions and one or more processors to execute the instructions to perform operations, the operations including: providing, in response to a selection of a plurality of items of content, a user interface including a first portion and a second portion, the first portion including a summary description generated via one or more machine-learned models based on the plurality of items of content and the second portion including a plurality of user interface elements configured to perform an operation with respect to at least one of the summary description or the plurality of items of content.

### FIELD

The disclosure relates generally to generating content via one or more machine-learned models based on source content that is selected (identified) by a user. For example, the disclosure relates to methods and computing devices for generating content by implementing a notebook application to obtain the source content to assist the user in managing content, organizing content, creating content, etc.

### BACKGROUND

According to current computing systems, large language models (LLMs) are capable of interacting with textual content. For example, a user may copy and paste content from one document into a chat box to query the LLM about the content. The LLM may provide an output (e.g., a summary) regarding the content.

### SUMMARY

Aspects and advantages of embodiments of the disclosure will be set forth in part in the following description, or can be learned from the description, or can be learned through practice of the example embodiments.

In one or more example embodiments, a computing device for generating organizing, managing, and creating content is provided. For example, the computing device includes: one or more memories configured to store instructions; and one or more processors configured to execute the instructions to perform operations, the operations comprising: providing, in response to a selection of a plurality of items of content, a user interface including a first portion and a second portion, the first portion including a summary description generated via one or more machine-learned models based on the plurality of items of content and the second portion including a plurality of user interface elements configured to perform an operation with respect to at least one of the summary description or the plurality of items of content.

In some implementations, the operations further comprise: receiving a selection of the plurality of items of content; and implementing the one or more machine-learned models to generate the summary description based on the plurality of items of content.

In some implementations, the plurality of user interface elements include a first user interface element comprising a suggested query, and the operations further comprise: receiving a selection of the first user interface element; and implementing the one or more machine-learned models to generate a response to the suggested query based on at least one of the summary description or the plurality of items of content.

In some implementations, the operations further comprise providing the user interface a third portion to provide for display a dialogue including the suggested query and the response.

In some implementations, the third portion includes a citation user interface element which indicates a number of items of content from among the plurality of items of content referenced by the one or more machine-learned models to generate the response.

In some implementations, the operations further comprise: in response to receiving a selection of the citation user interface element, providing, for display in a fourth portion of the user interface, content from one or more items of content from among the plurality of items of content used to generate the response.

In some implementations, the third portion includes a note generation user interface element, and the operations further comprise: in response to receiving a selection of the note generation user interface element, generating a note which includes content from the suggested query and the response, and storing the note.

In some implementations, the plurality of user interface elements include a first user interface element configured to generate a note, and the operations further comprise: providing the user interface a third portion which includes content from one or more items of content from among the plurality of items of content; receiving a selection of a portion of the content from the one or more items of content from among the plurality of items of content; receiving a selection of the first user interface element; and in response to receiving the selection of the portion of the content and the first user interface element, generating, via the one or more machine-learned models based on the portion of the content, the note which includes a summary of the portion of the content.

In some implementations, the plurality of user interface elements include a first user interface element configured to add content to an existing note, and the operations further comprise: providing the user interface a third portion which includes content from one or more items of content from among the plurality of items of content; receiving a selection of a portion of the content from the one or more items of content from among the plurality of items of content; receiving a selection of the first user interface element; and in response to receiving the selection of the portion of the content and the first user interface element, adding the portion of the content to the existing note.

In some implementations, the first portion further includes at least one key topic user interface element comprising at least one key topic relating to the summary description of the plurality of items of content, and the operations further comprise receiving a selection of the at least one key topic user interface element; and implementing the one or more machine-learned models to generate an output relating to the at least one key topic based on at least one of the summary description or the plurality of items of content.

In some implementations, the operations further comprise providing the user interface a third portion to provide for display a dialogue including the key topic and the output relating to the at least one key topic.

In some implementations, the operations further comprise: providing the user interface a third portion to provide for display at least one note generated via the one or more machine-learned models based on the plurality of items of content.

In some implementations, the third portion includes a citation user interface element which indicates a number of items of content from among the plurality of items of content referenced by the one or more machine-learned models to generate the at least one note.

In some implementations, the operations further comprise: in response to receiving a selection of the citation user interface element, providing, for display in a fourth portion of the user interface, content from one or more items of content from among the plurality of items of content used to generate the note.

In some implementations, the operations further comprise: in response to receiving the selection of the citation user interface element, providing, for display in the fourth portion of the user interface, contextual content about the content from the one or more items of content from among the plurality of items of content used to generate the note.

In some implementations, the plurality of user interface elements include a first user interface element configured to generate new content based on one or more notes, and the operations further comprise: providing the user interface a third portion to provide for display a plurality of notes generated via the one or more machine-learned models based on the plurality of items of content; receiving a selection of the plurality of notes; receiving a selection of the first user interface element; and in response to receiving the selection of the plurality of notes and the first user interface element, generate the new content based on the plurality of notes.

In some implementations, the operations further comprise: generating, via the one or more machine-learned models, a graphical image representing the plurality of items of content; and providing a folder including the graphical image, the folder storing the plurality of items of content and a project file including the summary description.

In some implementations, the second portion includes a text entry box to receive a query from a user, and the operations further comprise: implementing the one or more machine-learned models to generate a response to the query based on at least one of the summary description or the plurality of items of content.

In one or more example embodiments, a computing device for generating organizing, managing, and creating content is provided. For example, the computing device includes: one or more memories configured to store instructions; and one or more processors configured to execute the instructions to perform operations, the operations comprising: receiving an input to create a notebook; receiving a selection of a plurality of items of content to add to the notebook; in response to receiving the selection of the plurality of items of content, implementing one or more machine-learned models to generate a summary description based on the plurality of items of content and at least one of a key topic user interface element indicative of a topic of the plurality of items of content or a selectable user interface element indicative of a query relating to the plurality of items of content; and providing a user interface including a first portion and a second portion, the first portion including the summary description and the second portion including the selectable user interface element.

In one or more example embodiments, a computer-implemented method for organizing, managing, and creating content is provided. The computer-implemented method comprises providing, by a computing system and in response to a selection of a plurality of items of content, a user interface including a first portion and a second portion, the first portion including a summary description generated via one or more machine-learned models based on the plurality of items of content and the second portion including a plurality of user interface elements configured to perform an operation with respect to at least one of the summary description or the plurality of items of content.

In one or more example embodiments, a computer-implemented method for organizing, managing, and creating content is provided. The computer-implemented method comprises receiving, by a computing system, an input to create a notebook; receiving, by the computing system, a selection of a plurality of items of content to add to the notebook; in response to receiving the selection of the plurality of items of content, implementing, by the computing system, one or more machine-learned models to generate a summary description based on the plurality of items of content and at least one of a key topic user interface element indicative of a topic of the plurality of items of content or a selectable user interface element indicative of a query relating to the plurality of items of content; and providing, by the computing system, a user interface including a first portion and a second portion, the first portion including the summary description and the second portion including the selectable user interface element.

In one or more example embodiments, a computer-readable medium (e.g., a non-transitory computer-readable medium) which stores instructions that are executable by one or more processors of a computing system is provided. In some implementations the computer-readable medium stores instructions which may include instructions to cause the one or more processors to perform one or more operations which are associated with any of the methods described herein (e.g., operations of the server computing system and/or operations of the computing device). The computer-readable medium may store additional instructions to execute other aspects of the server computing system and computing device and corresponding methods of operation, as described herein.

These and other features, aspects, and advantages of various embodiments of the disclosure will become better understood with reference to the following description, drawings, and appended claims. The accompanying drawings, which are incorporated in and constitute a part of this specification, illustrate example embodiments of the disclosure and, together with the description, serve to explain the related principles.

### BRIEF DESCRIPTION OF THE DRAWINGS

Detailed discussion of example embodiments directed to one of ordinary skill in the art is set forth in the specification, which makes reference to the appended drawings, in which:

FIGS. 1A-1B depict example systems according to according to one or more example embodiments of the disclosure;

FIG. 2 illustrates a flow diagram of an example, non-limiting computer-implemented method, according to one or more example embodiments of the disclosure;

FIG. 3 depicts an example block diagram of a computing device, according to one or more example embodiments of the disclosure;

FIGS. 4A-4H illustrate example user interface screens of a notebook application, according to one or more example embodiments of the disclosure;

FIGS. 5A-5B illustrate example user interface screens of a notebook application, according to one or more example embodiments of the disclosure;

FIGS. 6A-6B illustrate further example user interface screens of a notebook application, according to one or more example embodiments of the disclosure;

FIG. 7 illustrates example notebooks or projects which can be represented in a particular manner, according to one or more example embodiments of the disclosure;

FIG. 8A depicts a block diagram of an example computing system for organizing, managing, and creating content by implementing one or more machine-learned models with respect to source content selected by a user, according to one or more example embodiments of the disclosure;

FIG. 8B depicts a block diagram of an example computing device for organizing, managing, and creating content by implementing one or more machine-learned models with respect to source content selected by a user, according to one or more example embodiments of the disclosure;

FIG. 8C depicts a block diagram of an example computing device for organizing, managing, and creating content by implementing one or more machine-learned models with respect to source content selected by a user, according to one or more example embodiments of the disclosure.

### DETAILED DESCRIPTION

Reference now will be made to embodiments of the disclosure, one or more examples of which are illustrated in the drawings, wherein like reference characters denote like elements. Each example is provided by way of explanation of the disclosure and is not intended to limit the disclosure. In fact, it will be apparent to those skilled in the art that various modifications and variations can be made to disclosure without departing from the scope or spirit of the disclosure. For instance, features illustrated or described as part of one embodiment can be used with another embodiment to yield a still further embodiment. Thus, it is intended that the disclosure covers such modifications and variations as come within the scope of the appended claims and their equivalents.

Terms used herein are used to describe the example embodiments and are not intended to limit and/or restrict the disclosure. The singular forms “a,” “an” and “the” are intended to include the plural forms as well, unless the context clearly indicates otherwise. In this disclosure, terms such as “including”, “having”, “comprising”, and the like are used to specify features, numbers, steps, operations, elements, components, or combinations thereof, but do not preclude the presence or addition of one or more of the features, elements, steps, operations, elements, components, or combinations thereof.

It will be understood that, although the terms first, second, third, etc., may be used herein to describe various elements, the elements are not limited by these terms. Instead, these terms are used to distinguish one element from another element. For example, without departing from the scope of the disclosure, a first element may be termed as a second element, and a second element may be termed as a first element.

The term “and/or” includes a combination of a plurality of related listed items or any item of the plurality of related listed items. For example, the scope of the expression or phrase “A and/or B” includes the item “A”, the item “B”, and the combination of items “A and B”.

In addition, the scope of the expression or phrase “at least one of A or B” is intended to include all of the following: (1) at least one of A, (2) at least one of B, and (3) at least one of A and at least one of B. Likewise, the scope of the expression or phrase “at least one of A, B, or C” is intended to include all of the following: (1) at least one of A, (2) at least one of B, (3) at least one of C, (4) at least one of A and at least one of B, (5) at least one of A and at least one of C, (6) at least one of B and at least one of C, and (7) at least one of A, at least one of B, and at least one of C.

According to current computing systems, large language models (LLMs) are capable of interacting with textual content. However, current computing systems require significant effort to create a specific prompt for a LLM to process. For example, a user may be required to copy and paste content from one document into a chat box to query the LLM about the content. This switching between multiple windows or applications results in significant amounts of wasted computational time and resources (e.g., processor cycles).

According to examples of the disclosure, a computing system (computing platform, computing device) is configured to create a new type of output (e.g., an outline, a report, a summary, etc.) via one or more machine-learned models, based on source content provided to the computing system (e.g., by the user). For example, the computing system may be configured to receive source content selected by a user and generate, via one or more machine-learned models, a summary of the source content including an identification of one or more topics related to the source content.

As an example, a user may identify and select a subset of documents (e.g., four documents) from a plurality of documents (a large corpus of documents) relating to a topic (e.g., modern American history in the 1990s) which are provided to the computing system. The computing system may include one or more machine-learned models configured to receive as an input the selected documents and to provide as an output a summary (or a report, a paper, an outline, etc.) relating to the selected documents and an identification of key topics (e.g., via a document guide).

In some implementations, the computing system is configured to implement a semantic retrieval method (e.g., clustering) and one or more machine-learned models (e.g., one or more LLMs) to generate a summary, key topics, and suggested queries (e.g., questions) to produce a document guide for content identified or indicated by the user (e.g., based on a body of text found in the content).

For example, in some implementations the computing system may be configured to receive source content from the user. For example, the user may upload source content (e.g., documents, imagery, sound files, websites, videos, presentations, PDFs, etc.). In some implementations, the computing system may be configured to, in response to the user uploading source content, automatically generate information including a summary of the source content, generate top themes found in the source content, generate suggested topics and questions to help the user explore the source content further, etc. The information may be presented via a user interface. The user interface may be configured to receive an input from the user (e.g., via a touch-input, mouse-click, etc.) on a user interface element corresponding to a theme, question, etc., In response to receiving the input from the user, the computing system may be configured to respond to the input, for example, by providing an answer via one or more machine-learned models to the question or theme query, based on the source content.

In some implementations, the computing system may be configured to, in response to the user uploading source content, automatically generate information including a report, an outline, or a rewrite of the original content, so as to generate new content based on the source content identified (selected) by the user. For example, the user may request that the computing system identify a specified number of themes from one or more documents, to summarize client interactions occurring over a specified duration of time (e.g., the least two weeks), to generate a specified number of ideas based on a source document, etc.

In some implementations, the source content that is relied upon or referenced by the LLMs may be selected (e.g., curated) by the user. For example, the user may consider or indicate that the selected source content is trustworthy (e.g., trusted source content, authoritative source content, etc.) or has a higher priority compared to other content which does not have such a designation. Therefore, the one or more machine-learned models are configured to generate summaries of content, or generate new content, based on trusted source content, improving the accuracy and reliability of information and data provided to the user. Further, the one or more machine-learned models are configured to answer questions about the source content based on the trusted source content, improving the accuracy and reliability of information and data provided as answers to questions posed by the user.

In some implementations, the computing system can be configured to discover, add, or remove source content. For example, the user may add or remove source content. For example, the user may provide an input requesting the computing system to discover source content (e.g., by conducting a search for scholarly articles regarding a certain topic) and the user may add the discovered source content as part of the selected source content which is deemed trustworthy by the user (and/or the computing system).

In some implementations, the computing system may be configured to receive an additional source content by the user creating a new note, by the user uploading the source content to the computing system, by adding the source content via a website, etc. The computing system may be configured to generate or receive metadata concerning the added source content. For example, the metadata may include one or more of a title, an author, a date of upload, a date associated with the creation of the source content, a uniform resource location (URL) associated with the source content, etc.

In some implementations, the computing system may be configured to delete or remove a source content by the user selecting the source content and providing an input requesting that the source content be deleted (e.g., from the notepad application). In some implementations, the source content may be deleted as a source relied upon for generating summaries, key topics, etc., in the notepad application, but an original copy of the source content may be maintained elsewhere.

In some implementations, the computing system can be configured to receive a user input via a text entry box (e.g., an open-ended text entry box). For example, the user input may be in the form of a question (e.g., “What did Nixon say in his speech about automobile use”). For example, the user input may be in the form of a theme or idea (e.g., “Nixon automobile crisis” or “What is this document about?”).

The computing system may be configured to, via one or more machine-learned models, provide a response to the user input based on the selected source content. In some implementations, the computing system is configured to indicate the number of sources (citations) that was relied upon for providing the response. In some implementations, the computing system is configured to provide for presentation a source (citation) which was relied upon for a particular passage in the response. In some implementations, the computing system is configured to provide additional context regarding the source (citation) which was relied upon for the particular passage in the response. For example, the computing system may indicate the passage (e.g., a sentence or paragraph) from the source for which a portion of the response was based on and may further indicate a preceding and/or subsequent passage from the source to provide further context concerning the particular passage.

In some implementations, the computing system may be configured to store one or more passages (e.g., snippets) from a generated response (answer) to a query (question) input by the user. For example, the one or more passages may be stored in a specified area of a notepad application. The specified area may be referred to as a scratchpad and each item of information stored in the scratchpad may be referred to as a note. The one or more passages may be selected by the user for storing as a first note in the scratchpad. In some implementations, citations can be stored in the scratchpad as a second note. In some implementations, the user can select (e.g., highlight) a particular passage from a citation (source content) for storing in the scratchpad as a third note. In some implementations, the user can store their own passage or comments as a written note (fourth note).

According to examples of the disclosure, the computing system may be configured to provide a notepad application which is configured to generate an output (e.g., an outline, a report, a summary, etc.) via one or more machine-learned models, based on source content provided to the notebook application (e.g., by the user). The notebook application may be configured to allow a user to create various projects to complete various tasks. Each project may be configured to act in a manner similar to a folder by which a user can store various information to each project. In some implementations, an individual scratchpad may correspond to or be dedicated to a particular project. In some implementations, the notebook application may be configured to receive the source content as specified by the user. The notebook application may be configured to add, delete, or modify projects according to an input received from a user. Each project may be provided a default name, a name provided by the user, or a name generated by the notebook application (e.g., via one or more machine-learned models) based on the information stored in the project (e.g., based on the source content).

In some implementations, in response to source content being provided to the notebook application, the notebook application may be configured to automatically generate (e.g., using one or more machine-learned models, one or more generative machine-learned models, etc.), a graphical image (e.g., an emoji, an icon, etc.) or graphical animation which corresponds to or represents the source content. In some implementations, the graphical image or graphical animation may be overlaid on a folder which is provided as a user interface element that, when selected, causes the folder to open and display the contents of the folder to the user. In addition, or alternatively, in some implementations, in response to the source content being provided to the notebook application, the notebook application may be configured to automatically generate (e.g., using one or more machine-learned models, one or more generative machine-learned models, etc.), a textual description (name) which corresponds to or represents the source content. The textual description may be overlaid on the folder which is provided as a user interface element that, when selected, causes the folder to open and display the contents of the folder to the user.

One or more technical benefits of the disclosure include generating content via one or more machine-learned models, based on particular items of content selected by a user. Current methods for a large language model (LLM) to generate an output require a user to copy and paste content from one document into a chat box to query the LLM about the content. Switching between multiple windows or applications results in significant amounts of wasted computational time and resources (e.g., processor cycles). In contrast to current methods, a summary regarding user-selected items of content (e.g., source content) can be automatically generated via a notebook application and one or more machine-learned models, in response to a user uploading the items of content. Therefore, a user need not switch between applications or windows, or provide a prompt.

Another technical benefit of the disclosure includes one or more machine-learned models providing suggested queries based on items of content selected by the user, suggested key topics based on items of content selected by the user, selectable chips based on an output of a response, and the like. A user can select a suggested query and the one or more machine-learned models may be configured to provide a response to the query based on the items of content selected by the user. Providing the suggested query automatically saves computing resources (e.g., networking resources including bandwidth, processor cycles, etc.) by not requiring the user to input the suggested query).

Another technical benefit of the disclosure includes one or more machine-learned models generating content based on items of content selected by the user and/or based on notes selected by the user. Generation of the content can save time and computing resources by not requiring a user to cut and paste content from multiple sources to generate new content (e.g., an outline, an essay, a report, etc.) which is based on a plurality of items of content.

Another technical benefit of the disclosure includes one or more machine-learned models generating a graphical image or animation to display in an overlaid manner on a folder to indicate content which is saved in the folder. The graphical image or animation can improve search capabilities and save computing resources that may otherwise be expended by a user opening and closing folders which do not contain content that the user is actually looking for.

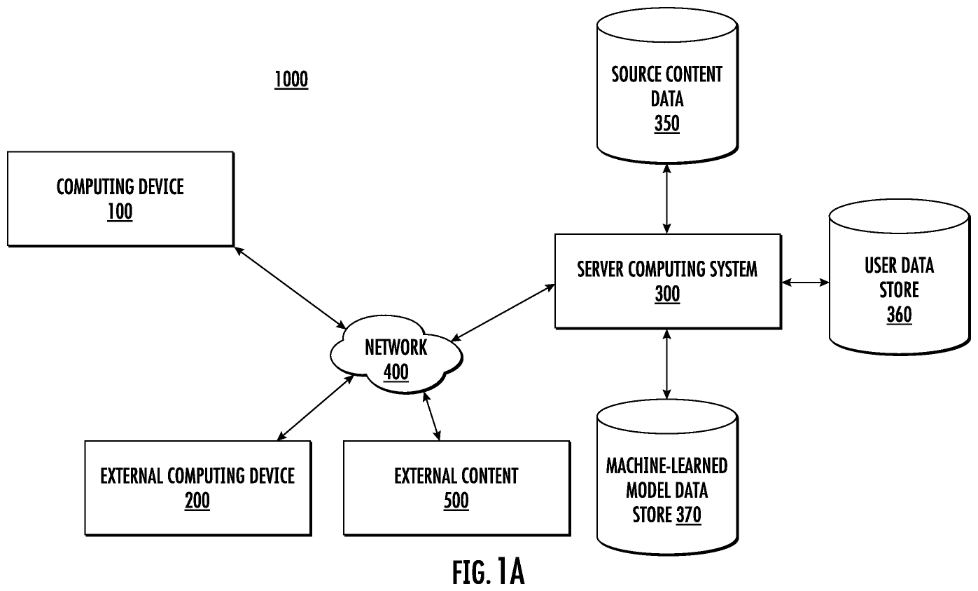

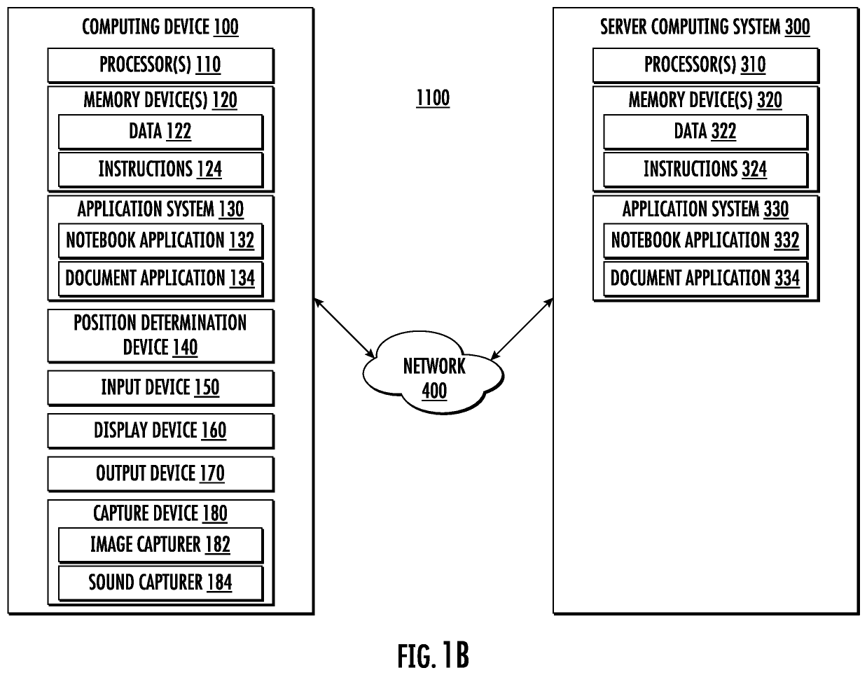

Referring now to the drawings, FIG. 1A is an example system according to one or more example embodiments of the disclosure. FIG. 1A illustrates an example of a system 1000 which includes a computing device 100, an external computing device 200, a server computing system 300, and external content 500, which may be in communication with one another over a network 400. For example, the computing device 100 and the external computing device 200 can include any of a personal computer, a smartphone, a tablet computer, a global positioning service device, a smartwatch, and the like. The network 400 may include any type of communications network including a wired or wireless network, or a combination thereof. The network 400 may include a local area network (LAN), wireless local area network (WLAN), wide area network (WAN), personal area network (PAN), virtual private network (VPN), or the like. For example, wireless communication between elements of the example embodiments may be performed via a wireless LAN, Wi-Fi, Bluetooth, ZigBee, Wi-Fi direct (WFD), ultra wideband (UWB), infrared data association (IrDA), Bluetooth low energy (BLE), near field communication (NFC), a radio frequency (RF) signal, and the like. For example, wired communication between elements of the example embodiments may be performed via a pair cable, a coaxial cable, an optical fiber cable, an Ethernet cable, and the like. Communication over the network 400 can use a wide variety of communication protocols (e.g., TCP/IP, HTTP, SMTP, FTP), encodings or formats (e.g., HTML, XML), and/or protection schemes (e.g., VPN, secure HTTP, SSL).

As will be explained in more detail below, in some implementations the computing device 100 and/or server computing system 300 may form part of an application system which can provide a tool for users to manage or organize information (e.g., documents, imagery, etc.), for example, via one or more machine-learned models.

In some example embodiments, the server computing system 300 may obtain data from one or more of a source content data store 350, a user data store 360, and a machine-learned model data store 370, to implement various operations and aspects of the application system as disclosed herein. The source content data store 350, user data store 360, and machine-learned model data store 370 may be integrally provided with the server computing system 300 (e.g., as part of the one or more memory devices 320 of the server computing system 300) or may be separately (e.g., remotely) provided. Further, source content data store 350, user data store 360, and machine-learned model data store 370 can be combined as a single data store (database), or may include a plurality of respective data stores. Data stored in one data store (e.g., the source content data store 350) may overlap with some data stored in another data store (e.g., the user data store 360). In some implementations, one data store (e.g., the machine-learned model data store 370) may reference data that is stored in another data store (e.g., the user data store 360).

In some examples, the source content data store 350 can store any kind of information or content. For example, the source content data store 350 can include books, product manuals, legal opinions, academic papers, proprietary data files, patent documents, web pages, emails, forum posts, social media posts, videos, images, geographic information, or any other type or manner of content which may be stored or accessed in digital form (e.g., in a database, memory device, etc.). In some implementations, information may be stored in the source content data store 350 by the user selecting certain documents, images, or other content to store in the source content data store 350.

In some examples, the user data store 360 can include information regarding one or more user profiles, including a variety of user data such as user preference data, user demographic data, user calendar data, user social network data, user historical travel data, and the like. For example, the user data store 360 can include, but is not limited to, email data including textual content, images, email-associated calendar information, or contact information; social media data including comments, reviews, check-ins, likes, invitations, contacts, or reservations; calendar application data including dates, times, events, description, or other content; virtual wallet data including purchases, electronic tickets, coupons, or deals; scheduling data; location data; SMS data; or other suitable data associated with a user account. According to one or more examples of the disclosure, the data can be analyzed to determine preferences of the user with respect to generating, managing, and/or organizing content, for example, to automatically generate a summary of a document in a particular manner or style, automatically provide customized features with respect to content, to provide suggestions, recommendations, and/or questions relating to certain content identified by the user as source content, etc.

The user data store 360 is provided to illustrate potential data that could be analyzed, in some embodiments, by the computing device 100 and/or server computing system 300 to identify user preferences, to make recommendations, to generate, manage, and/or organize content, etc., However, such user data may not be collected, used, or analyzed unless the user has consented after being informed of what data is collected and how such data is used. Further, in some embodiments, the user can be provided with a tool (e.g., in a notebook application or via a user account) to revoke or modify the scope of permissions. In addition, certain information or data can be treated in one or more ways before it is stored or used, so that personally identifiable information is removed or stored in an encrypted fashion. Thus, particular user information stored in the user data store 360 may or may not be accessible to the computing device 100 and/or server computing system 300 based on permissions given by the user, or such data may not be stored in the user data store 360 at all.

Machine-learned model data store 370 can store machine-learned models which can be retrieved and implemented by the server computing system 300 for generating distilled or fine-tuned machine-learned models (e.g., distilled or fine-tuned generative machine-learned models) that, in some implementations, can also be provided to the computing device 100. Machine-learned model data store 370 can also store distilled or fine-tuned machine-learned models (e.g., distilled or fine-tuned generative machine-learned models) which can be retrieved and implemented by the computing device 100. In some implementations, the computing device 100 can retrieve and implement machine-learned models which are large parameter models that have not been fine-tuned or distilled. The machine-learned models (including large parameter models and distilled or fine-tuned models) stored at the machine-learned model data store 370 can include generative machine-learned models respectively associated with different types of content (e.g., different genres or subjects, different kinds of content including imagery, videos, and text, different styles of content including outlines, reports, spreadsheets, etc.). The machine-learned models may include large language models (e.g., the Bidirectional Encoder Representations from Transformers (BERT) large language model) and general, multimodal models (e.g., Gemini). The machine-learned models may include generative artificial intelligence (AI) models (e.g., Bard) which may implement generative adversarial networks (GANs), transformers, variational autoencoders (VAEs), neural radiance fields (NeRFs), and the like.

External content 500 can be any form of external content including news articles, webpages, video files, audio files, written descriptions, ratings, game content, social media content, photographs, commercial offers, transportation method, weather conditions, sensor data obtained by various sensors, or other suitable external content. The computing device 100, external computing device 200, and server computing system 300 can access external content 500 over network 400. External content 500 can be searched by computing device 100, external computing device 200, and server computing system 300 according to known searching methods and search results can be ranked according to relevance, popularity, or other suitable attributes, including location-specific filtering or promotion.

Referring now to FIG. 1B, example block diagrams of a computing device and server computing system according to one or more example embodiments of the disclosure will now be described. Although computing device 100 is represented in FIG. 1B, features of the computing device 100 described herein are also applicable to the external computing device 200.

The computing device 100 may include one or more processors 110, one or more memory devices 120, an application system 130, a position determination device 140, an input device 150, a display device 160, an output device 170, and a capture device 180. The server computing system 300 may include one or more processors 310, one or more memory devices 320, and an application system 330.

For example, the one or more processors 110, 310 can be any suitable processing device that can be included in a computing device 100 or server computing system 300. For example, the one or more processors 110, 310 may include one or more of a processor, processor cores, a controller and an arithmetic logic unit, a central processing unit (CPU), a graphics processing unit (GPU), a digital signal processor (DSP), an image processor, a microcomputer, a field programmable array, a programmable logic unit, an application-specific integrated circuit (ASIC), a microprocessor, a microcontroller, etc., and combinations thereof, including any other device capable of responding to and executing instructions in a defined manner. The one or more processors 110, 310 can be a single processor or a plurality of processors that are operatively connected, for example in parallel.

The one or more memory devices 120, 320 can include one or more non-transitory computer-readable storage mediums, including a Read Only Memory (ROM), Programmable Read Only Memory (PROM), Erasable Programmable Read Only Memory (EPROM), and flash memory, a USB drive, a volatile memory device including a Random Access Memory (RAM), a hard disk, floppy disks, a blue-ray disk, or optical media such as CD ROM discs and DVDs, and combinations thereof. However, examples of the one or more memory devices 120, 320 are not limited to the above description, and the one or more memory devices 120, 320 may be realized by other various devices and structures as would be understood by those skilled in the art.

For example, the one or more memory devices 120 can also include data 122 and instructions 124 that can be retrieved, manipulated, created, or stored by the one or more processors 110. In some example embodiments, such data can be accessed and used as input to implement notebook application 132, and to execute the instructions to perform operations including: providing a user interface including a first portion and a second portion, wherein the first portion includes a textual summary generated via one or more machine-learned models based on a plurality of documents selected by a user and the second portion includes a plurality of user interface elements to perform an operation with respect to the textual summary, as described according to examples of the disclosure.

For example, the one or more memory devices 320 can also include data 322 and instructions 324 that can be retrieved, manipulated, created, or stored by the one or more processors 310. In some example embodiments, such data can be accessed and used as input to implement notebook application 332, and to execute the instructions to perform operations including: providing a user interface including a first portion and a second portion, wherein the first portion includes a textual summary generated via one or more machine-learned models based on a plurality of documents selected by a user and the second portion includes a plurality of user interface elements to perform an operation with respect to the textual summary, as described according to examples of the disclosure.

In some example embodiments, the computing device 100 includes an application system 130. For example, the application system 130 may include the notebook application 132 and a document application 134 (e.g., a word processing application, a spreadsheet application, a presentation application, an imagery application, etc.). The application system 130 can include various other applications including text messaging applications, email applications, dictation applications, virtual keyboard applications, browser applications, map applications, social media applications, navigation applications, etc.

According to examples of the disclosure, the notebook application 132 may be executed by the computing device 100 to provide a user of the computing device 100 a way to organize, manage, create, and interact with content, particularly with content that is curated or selected by the user. In some implementations, the notebook application 132 may be part of document application 134, or may be a standalone application. The notebook application 132 may be configured to be dynamically interactive according to various user inputs. Example implementations of the notebook application 132 are described herein, however the disclosure is not limited to these examples as various modifications may be made to the embodiments described herein.

In some examples, one or more aspects of the notebook application 132 may be implemented by the notebook application 332 of the server computing system 300 which may be remotely located, to organize, manage, create, and interact with content, in response to receiving an input from a user. In some examples, one or more aspects of the notebook application 332 may be implemented by the notebook application 132 of the computing device 100, to organize, manage, create, and interact with content, in response to receiving an input from a user.

According to examples of the disclosure, the document application 134 may be executed by the computing device 100 to provide a user of the computing device 100 a way organize, manage, create, and interact with content, particularly with content that is curated or selected by the user. The document application 134 can be any kind of application that pertains to documents (e.g., in a textual or visual format), and can include word processing applications, spreadsheet applications, presentation applications, visual applications, portable document format file applications, etc. In some implementations, the notebook application 132 and document application 134 may interact with each other. For example, content from a document that is created via document application 334 may be uploaded or stored for use with notebook application 132. In some implementations, notebook application 132 may be configured to generate a document (e.g., a report, an outline, a presentation, a spreadsheet) which can be compatible with (opened by or exported to) the document application 134.

In some examples, the document application 134 can be a dedicated application specifically designed to provide a particular service. In other examples, the document application 134 can be a general application (e.g., a web browser) and can provide access to a variety of different services via the network 400.

In some example embodiments, the computing device 100 includes a position determination device 140. Position determination device 140 can determine a current geographic location of the computing device 100 and communicate such geographic location to server computing system 300 over network 400. The position determination device 140 can be any device or circuitry for analyzing the position of the computing device 100. For example, the position determination device 140 can determine actual or relative position by using a satellite navigation positioning system (e.g. a GPS system, a Galileo positioning system, the GLObal Navigation satellite system (GLONASS), the BeiDou Satellite Navigation and Positioning system), an inertial navigation system, a dead reckoning system, based on IP address, by using triangulation and/or proximity to cellular towers or WiFi hotspots, and/or other suitable techniques for determining a position of the computing device 100.

The computing device 100 may include an input device 150 configured to receive an input from a user and may include, for example, one or more of a keyboard (e.g., a physical keyboard, virtual keyboard, etc.), a mouse, a joystick, a button, a switch, an electronic pen or stylus, a gesture recognition sensor (e.g., to recognize gestures of a user including movements of a body part), an input sound device or speech recognition sensor (e.g., a microphone to receive a voice input such as a voice command or a voice query), a track ball, a remote controller, a portable (e.g., a cellular or smart) phone, a tablet PC, a pedal or footswitch, a virtual-reality device, and so on. The input device 150 may also be embodied by a touch-sensitive display having a touchscreen capability, for example. For example, the input device 150 may be configured to receive an input from a user associated with the input device 150 for selecting content that is to be organized or managed, for selecting queries or actions with respect to content that is curated or selected by the user, etc.

The computing device 100 may include a display device 160 which displays information viewable by the user (e.g., a user interface screen). For example, the display device 160 may be a non-touch sensitive display or a touch-sensitive display. The display device 160 may include a liquid crystal display (LCD), a light emitting diode (LED) display, an organic light emitting diode (OLED) display, active matrix organic light emitting diode (AMOLED), flexible display, 3D display, a plasma display panel (PDP), a cathode ray tube (CRT) display, and the like, for example. However, the disclosure is not limited to these example displays and may include other types of displays. The display device 160 can be used by the application system 130 provided at the computing device 100 to display information to a user relating to an input (e.g., information relating to a document, to a note, to a project, etc., a user interface screen having user interface elements which are selectable by the user, etc.).

The computing device 100 may include an output device 170 to provide an output to the user and may include, for example, one or more of an audio device (e.g., one or more speakers), a haptic device to provide haptic feedback to a user (e.g., a vibration device), a light source (e.g., one or more light sources such as LEDs which provide visual feedback to a user), a thermal feedback system, and the like.

The computing device 100 may include a capture device 180 that is capable of capturing media content, according to various examples of the disclosure. For example, the capture device 180 can include an image capturer 182 (e.g., a camera) which is configured to capture images (e.g., photos, video, and the like). For example, the capture device 180 can include a sound capturer 184 (e.g., a microphone) which is configured to capture sound or audio (e.g., an audio recording) of a location. The media content captured by the capture device 180 may be transmitted to one or more of the server computing system 300, source content data store 350, user data store 360, and machine-learned model data store 370, for example, via network 400. For example, in some implementations, media content which is captured by the capture device 180 may be selected as source content by a user for use in creating a note with respect to a project. The media content can be provided as an input to one or more machine-learned models to generate a note, for example.

In accordance with example embodiments of the disclosure, the server computing system 300 can include one or more processors 310 and one or more memory devices 320 as described herein. The server computing system 300 may also include an application system 330 which is similar to the application system 130 described herein.

For example, the application system 330 may include a notebook application 332 which performs functions similar to those discussed above with respect to notebook application 132. In some implementations, one or more machine-learned models (e.g., generative machine-learned models, large language models, etc.) associated with the application system 330 may be configured to organize, manage, create, and interact with content based on source content that is curated or selected by a user. For example, one or more machine-learned models (e.g., generative machine-learned models, large language models, etc.) associated with the application system 330 may be configured to perform a first action (e.g., generate a summary or document guide with respect to source content selected by a user), while the computing device 100 may be configured to perform a second action (e.g., generate suggested actions, generate an outline or study guide based on a plurality of notes saved to a scratchpad). For example, a particular action to be performed by the application system 330 may vary according to a network status (e.g., an available bandwidth, a channel utilization status, a latency status, a throughput rate, etc.). In some implementations, one or more machine-learned models associated with the application system 330 may be configured to process a user input to generate information (e.g., semantic information) which can then be provided as an input to one or more other machine-learned models (e.g., generative machine-learned models, large language models, etc.) associated with the application system 330, to generate the content to be utilized with respect to a project for the notebook application 132 and/or notebook application 332.

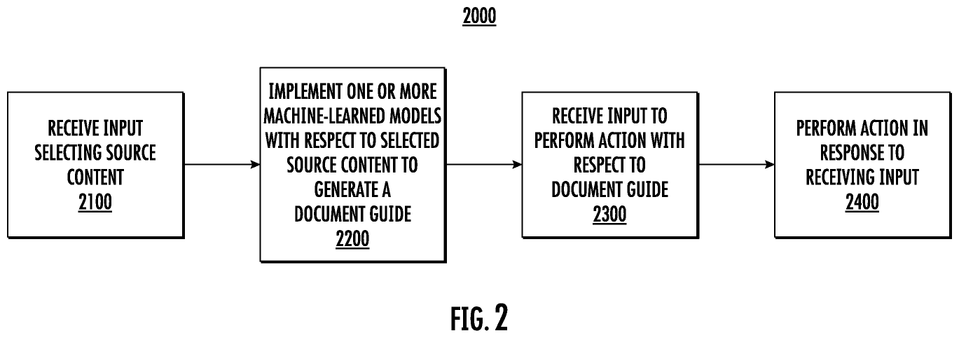

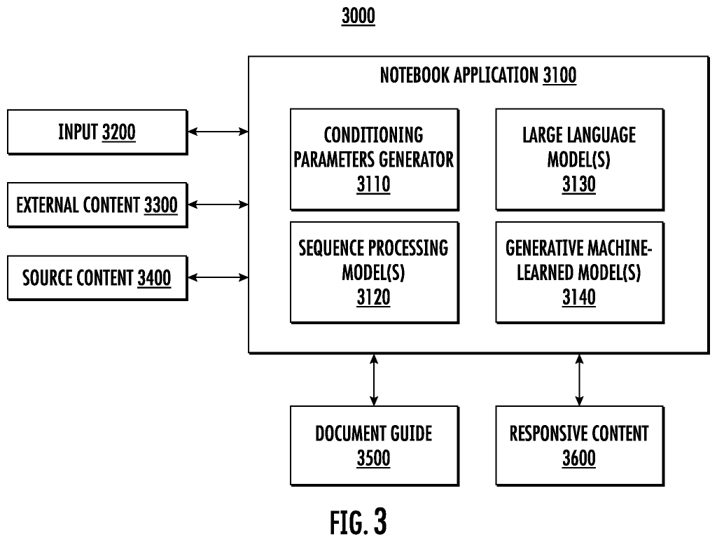

Examples of the disclosure are also directed to computer implemented methods for providing a user interface for organizing, managing, and creating content by implementing one or more machine-learned models with respect to source content selected by a user. FIG. 2 illustrates a flow diagram of an example, non-limiting computer-implemented method, according to one or more example embodiments of the disclosure. FIG. 3 illustrates a block diagram of a notebook application, according to one or more example embodiments of the disclosure.

The flow diagram of FIG. 2 illustrates a method 2000 for providing a user interface for organizing, managing, and creating content by implementing one or more machine-learned models with respect to source content selected by a user. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

Referring to FIG. 2, at operation 2100 the method 2000 includes a computing device receiving an input from a user relating to the selection of source content. As described herein, the computing device may be embodied as computing device 100, server computing system 300, or combinations thereof. For example, the input may be provided by the user via input device 150. For example, the input may be provided by selecting particular files or documents which are uploaded to the computing device for use by the notebook application 132. In some implementations, the content can be uploaded from a local memory, from another application (e.g., a portable document file application), from copied text, or from a website. The selected files, text, documents, etc. may be referred to as source content. In some implementations, the source content may be a subset of a larger corpus of content. The input may be provided or input to notebook application 132 or notebook application 332, for example.

In some implementations, a response to the input selecting the source content may be processed at computing device 100 without involving the server computing system 300. In some implementations, the input selecting the source content may be transmitted from computing device 100 to server computing system 300 and at least part of the response to the input may be processed by the server computing system 300. For example, the input relating to the selection of the source content may be provided at the computing device 100 and the server computing system 300 may be configured to perform an operation in response to receiving an indication of the input.

At operation 2200, the computing device may be configured to implement one or more machine-learned models with respect to the selected source content to generate a document guide. In some implementations, the document guide (source guide) generated by the one or more machine-learned models may include a summary of the source content and key topics relating to the source content. In some implementations, the document guide may further include one or more suggested queries (e.g., questions) that may be provided in the form of a selectable user interface element.

For example, the computing device can obtain information indicating that the user has selected source content. The computing device can process the source content with one or more machine-learned models (e.g., one or more large language models) to obtain a language output. The computing device can then use the one or more machine-learned models (e.g., one or more large language models) to generate a summarization output. In particular, a machine-learned large language model can be trained to process a variety of outputs to generate a language output. For example, the machine-learned large language model can process an embedding generated by a machine-learned embedding generation model, portions of the source content identified using the embedding generation model, language outputs generated using the machine-learned large language model or some other model, etc.

At operation 2300, the computing device may be configured to receive an input to perform an action with respect to the document guide. At operation 2400 the computing device may be configured to perform the action in response to receiving the input. For example, the input may be the selection of a suggested query and the action may include providing an answer to the question by implementing the one or more machine-learned models with respect to the source content. For example, the input may be a text input asking a question and the action may include providing an answer to the question by implementing the one or more machine-learned models with respect to the source content. For example, the input may be a selection of a portion of the summary and the action may include providing an output indicating particular sources from among the source content which were relied upon for generating the text associated with the selection of the portion of the summary.

Referring to FIG. 3, notebook application 3100 (which may correspond to notebook application 132 and/or notebook application 332) may include a conditioning parameters generator 3110, one or more sequence processing models 3120, one or more large language models 3130, and one or more generative machine-learned models 3140. The notebook application 3100 may receive an input 3200 from a user as discussed above with respect to operation 2100 and operation 2300 of FIG. 2. Conditioning parameters generator 3110 may be configured to generate conditioning parameters based at least in part on the input, wherein the conditioning parameters provide values for one or more conditions associated with content to be generated which relates at least in part to the input 3200 and source content 3400 selected by the user.

For example, source content 3400 can include any kind of document (e.g., in digital form) and may include books, product manuals, legal opinions, academic papers, proprietary data files, patent documents, web pages, emails, forum posts, social media posts, videos, images, geographic information, or any other type or manner of content which may be stored or accessed in digital form (e.g., in a database, memory device, etc.). In some implementations, source content 3400 may be stored in the source content data store 350 by the user selecting certain documents, images, or other content to store in the source content data store 350. In some implementations, source content 3400 may be stored at the computing device 100 or server computing system 300.

To generate the conditioning parameters, the conditioning parameters generator 3110 may be configured to retrieve values for the one or more conditions associated with the input. For example, to generate the conditioning parameters, the conditioning parameters generator 3110 may be configured to extract the values for the one or more conditions from the input. The input may include information indicative of the user's intent or requirements. In some implementations, the conditioning parameters generator 3110 (or the one or more sequence processing models 3120 or the one or more large language models 3130) may be configured to extract information from the input 3200 to identify values for the one or more conditions, and the conditioning parameters generator 3110 may be configured to generate the conditioning parameters based on the extracted values. For example, the input itself may identify a color to be used for headings in a generated document (e.g., “blue font for the title”) or an attribute or feature (e.g., “circle bullet points”) that can be used to generate the conditioning parameters for generating a document related to the source content.

To generate the conditioning parameters, the conditioning parameters generator 3110 may be configured to infer the values for the one or more conditions from the input. The input may include information indicative of the user's intent or requirements. In some implementations, the conditioning parameters generator 3110 (or the one or more sequence processing models 3120 or the one or more large language models 3130) may be configured to infer information from the input 3200 to identify values for the one or more conditions, and the conditioning parameters generator 3110 may be configured to generate the conditioning parameters based on the inferred values. For example, the input may include a reference to a length (“short,” “long,” etc.) of the summary to be generated or of another document to be generated based on the source content, and the conditioning parameters generator 3110 (or the one or more sequence processing models 3120 or the one or more large language models 3130) may be configured to infer a value based on the input. For example, an input requesting the notebook application 3000 to generate a “short” essay may infer a value of about 500 words while a “long” essay may be associated with a value of about 2000 words. For example, the notebook application 3100 may be configured to ascertain an inferred value based on information via external content 3300.

In some implementations, the conditioning parameters generator 3110 may be configured to infer the values for the one or more conditions from the input by providing the input to one or more sequence processing models 3120, wherein the one or more sequence processing models 3120 are configured to output the values for the one or more conditions in response to or based on the query. The one or more sequence processing models 3120 may include one or more machine-learned models which are configured to process and analyze sequential data and to handle data that occurs in a specific order or sequence, including time series data, natural language text, or any other data with a temporal or sequential structure.

The one or more sequence processing models 3120 may receive an input including text and tokenize the input by breaking down the sequence of text into small units (tokens) to provide a structured representation of the input sequence. The one or more sequence processing models 3120 may represent the tokens as vectors in a continuous vector space by mapping each token to a high-dimensional vector, where the relationships between tokens (words) are reflected in the geometric relationships between their corresponding vector. For example, the one or more sequence processing models 3120 may receive an input including the text “How did the Cold War end?” and tokenize the input by breaking down the sequence of text into small units (tokens) (e.g., “How,” “Cold War,” and “end”), thereby providing a structured representation of the input sequence. In a word embedding, semantically similar words are closer together in the vector space. For example, the vectors for “war” and “battle” might be close to each other because of their semantic relationship, while the vectors for “war” and “peace” may be far apart compared to the vectors for “war” and “battle”.

The one or more large language models 3130 can be, or otherwise include, a model that has been trained on a large corpus of language training data in a manner that provides the one or more large language models 3130 with the capability to perform multiple language tasks. For example, the one or more large language models 3130 can be trained to perform summarization tasks, conversational tasks, simplification tasks, oppositional viewpoint tasks, etc. In particular, the one or more large language models 3130 can be trained to process a variety of outputs to generate a language output. For example, the one or more large language models 3130 can process an embedding generated by a machine-learned embedding generation model, portions of source content (e.g., document chunk(s)) identified using an embedding generation model, language outputs generated using the one or more large language models 3130 or some other model, etc.

The one or more generative machine-learned models 3140 may include a deep neural network or a generative adversarial network (GAN), variational autoencoders, stable diffusion machine-learned models, visual transformers, neural radiance fields (NeRFs), etc., to generate content (e.g., a summary, response to a query, etc.) with values for conditions associated with one or more features. For example, the computing device may include a database (e.g., machine-learned model data store 370) which is configured to store a plurality of generative machine-learned models respectively associated with a plurality of different types of content (e.g., different genres or subjects, different kinds of content including imagery, videos, and text, different styles of content including outlines, reports, spreadsheets, etc.). In some implementations, the computing device may be configured to retrieve, from among the one or more generative machine-learned models 3140, a generative machine-learned model associated with a particular type of content relating to the input.

In some implementations, the one or more generative machine-learned models 3140 may be trained on a large dataset of content (e.g., a large corpus of language training data) with corresponding information about the conditions associated with the content. During training, the one or more generative machine-learned models 3140 learn relationships between elements in an output (e.g., content) and conditions that influence them. This may involve the computing device adjusting each generative machine-learned model's internal parameters to generate realistic or accurate content (e.g., grammatically correct content, coherent content, etc.) based on the training data. The one or more generative machine-learned models 3140 may be trained on one or more training datasets including a plurality of reference images of the location. The one or more training datasets may include values for the one or more conditions.

In some implementations, the one or more generative machine-learned models 3140 are configured to generate the document guide 3500 in response to receiving the selection of source content 3400 and/or to generate responsive content 3600 which corresponds to content that is generated in response to the input to perform an action with respect to the document guide, etc., based on the conditioning parameters (and corresponding values for the one or more conditions) to make decisions for generating content.

In some implementations, the server computing system 300 may provide (transmit) content or a portion of the generated content to computing device 100 or the server computing system 300 may provide access to the generated content to the computing device 100. For example, the document guide 3500 may be generated at the server computing system 300 and stored at one or more computing devices (e.g., one or more of computing device 100, external computing device 200, server computing system 300, external content 500, source content data store 350, user data store 360, etc.).

In some implementations, after a document guide is generated and/or after an action is performed with respect to the document guide, the user can provide feedback or a further input relating to the content which is generated based on the source content provided and/or a query provided via the user, and one or more of the operations 2100 through 2400 can be repeated.

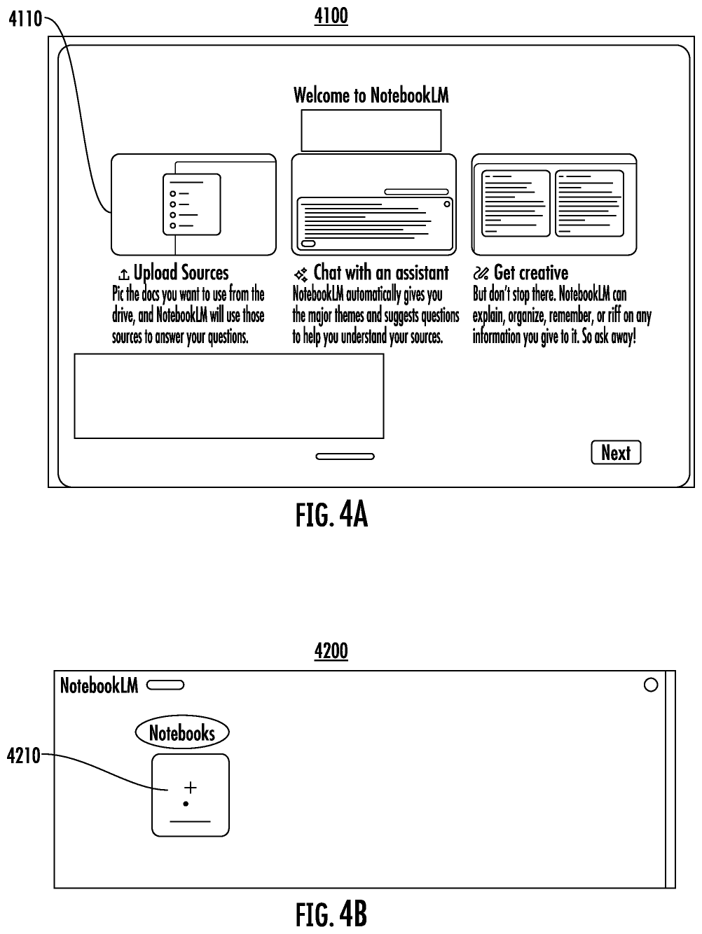

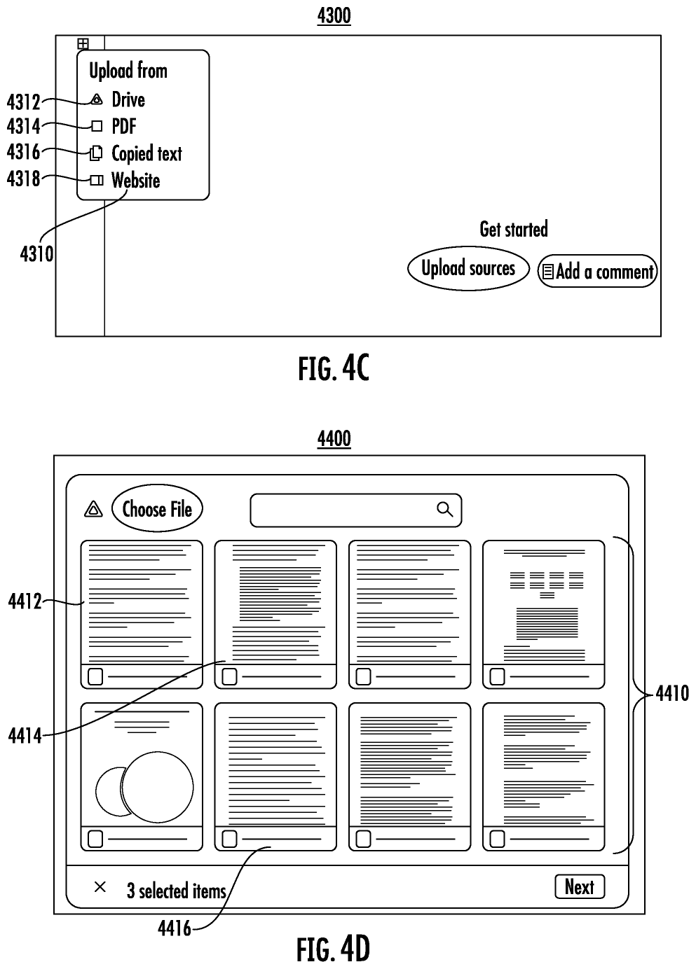

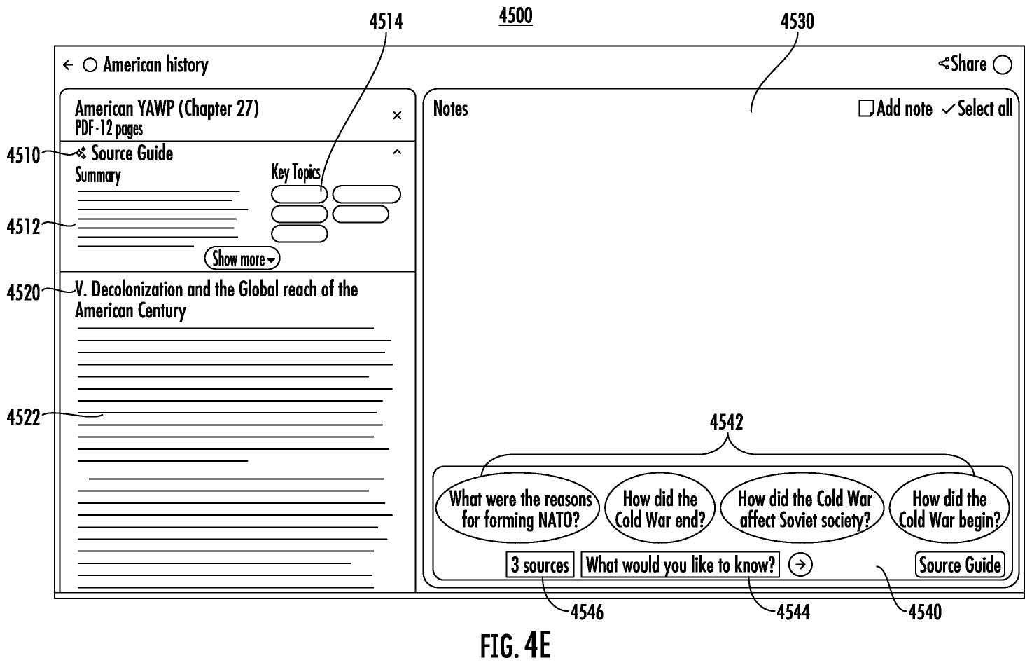

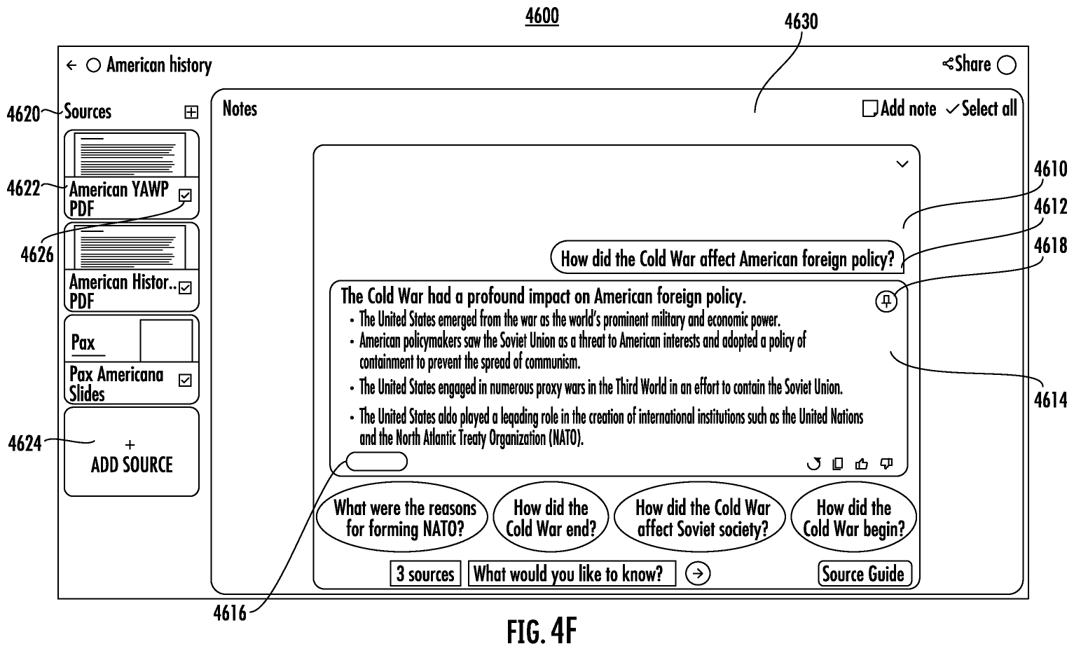

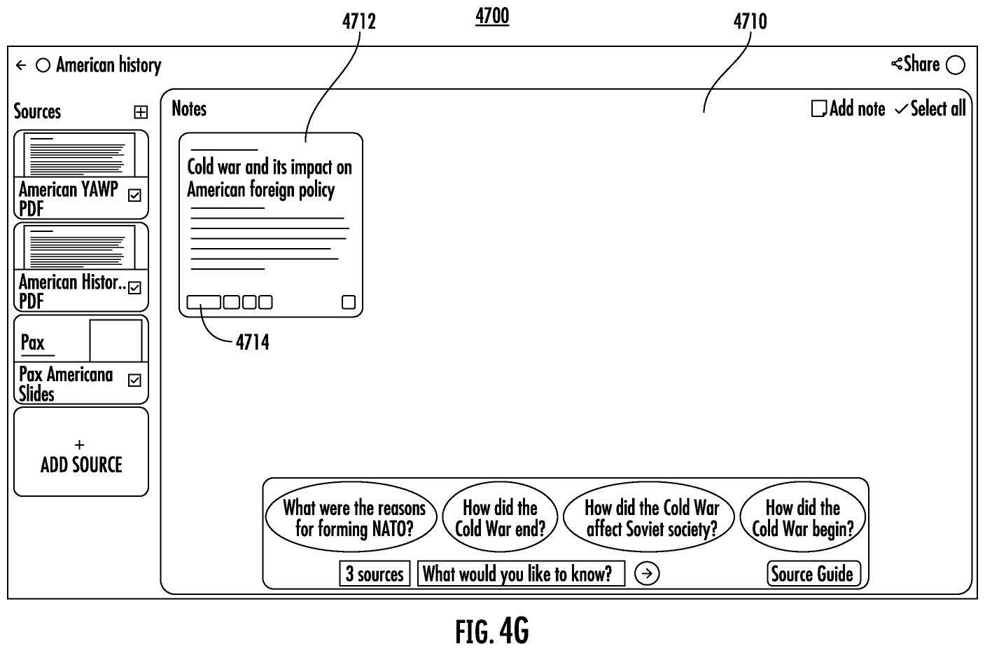

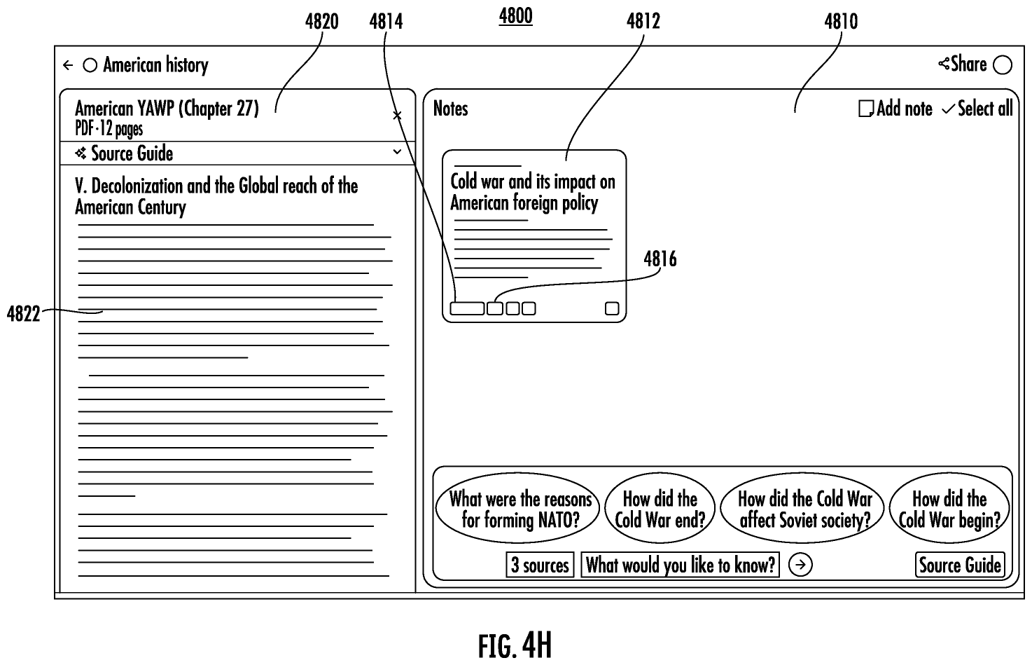

Examples of the disclosure are also directed to user-facing aspects by which a user can manage content, organize content, create content, etc., via a notebook application which is configured to implement one or more machine-learned models with respect to source content selected by the user. For example, FIGS. 4A through 4H illustrate examples of actions which can be implemented for a project in which a document guide is generated via one or more machine-learned models based on source content selected by a user, according to one or more example embodiments of the disclosure.

For example, FIG. 4A illustrates a first user interface screen (e.g., a startup user interface screen, a startup graphical user interface, etc.) of a notebook application, according to one or more example embodiments of the disclosure.

In FIG. 4A, first user interface screen 4100 depicts a user interface (e.g., a launch screen) which provides information about the notebook application 3100. In particular, notebook application 3100 is configured to present for display the first user interface screen 4100 which includes various information 4110 regarding features which are available in the notebook application 3100.

As illustrated in FIG. 4B, the notebook application 3100 is further configured to present for display a second user interface screen 4200 which includes a first user interface element 4210. For example, the first user interface element 4210 is associated with enabling a user to create a new notebook (a new project) by which a user can manage content, organize content, create content, etc., based on source content which the user can select or curate.

As illustrated in FIG. 4C, the notebook application 3100 is further configured to present for display a third user interface screen 4300 in response to a user providing an input to create a new notebook (e.g., via the selection of the first user interface element 4210). The third user interface screen 4300 includes a first portion 4310 having a plurality of selectable user interface elements that correspond to locations where the source content can be uploaded from. For example, first user interface element 4312 corresponds to a storage space which may be associated with a local computing device or a remote server system (e.g., a cloud server), or another storage device (e.g., a portable storage device). For example, second user interface element 4314 corresponds to a portable document format file, third user interface element 4316 corresponds to copied text, and fourth user interface element 4318 corresponds to content which can be uploaded from a particular website or URL.

As illustrated in FIG. 4D, the notebook application 3100 is further configured to present for display a fourth user interface screen 4400 in response to the selection of one of the plurality of selectable user interface elements that correspond to locations where the source content can be uploaded from, described with respect to FIG. 4C. The fourth user interface screen 4400 includes a first portion 4410 having a plurality of selectable items of source content (e.g., a plurality of documents, images, videos, etc.). For example, first user interface element 4412 corresponds to a first selected document, second user interface element 4414 corresponds to a second selected document (e.g., a portable document format file), and third user interface element 4416 corresponds to a third selected document. FIG. 4D illustrates that the user can curate or select particular items of source content which can be used for creating a notebook or project and which can be relied upon by one or more machine-learned models as input data for organizing content, managing content, creating content, etc.

As illustrated in FIG. 4E, the notebook application 3100 is further configured to present for display a fifth user interface screen 4500 in response to the selection of one or more items of content from the plurality of items of source content, described with respect to FIG. 4D. The fifth user interface screen 4500 includes a first portion 4510, a second portion 4520, a third portion 4530, and a fourth portion 4540. Each portion of the fifth user interface screen 4500 may correspond to a section or panel of the fourth user interface screen 4400 and can be associated with a different functionality.

For example, the first portion 4510 corresponds to a document guide (also referred to as a source guide) which includes a summary section 4512 and a key topics section 4514. The notebook application 3100 may be configured to generate the content (e.g., a textual description) associated with the summary section 4512 by implementing one or more machine-learned models as described herein with respect to FIG. 3, based on the selected source content (e.g., as described with respect to FIG. 4D). For example, the summary section 4512 may provide a brief summary associated with one or more of the items of content which comprise the selected source content. Likewise, the notebook application 3100 may be configured to generate the content (e.g., a textual description) associated with the key topics section 4514 by implementing one or more machine-learned models as described herein with respect to FIG. 3, based on the selected source content (e.g., as described with respect to FIG. 4D). For example, the key topics section 4514 may include one or more user interface elements which identify themes or important topics associated with one or more of the items of content which comprise the selected source content. Further, the notebook application 3100 may be configured to generate an output in response to a selection of one of the user interface elements in the key topics section 4514. The output may be a text summary or text explanation regarding the key topic corresponding to the selected user interface element, for example. The output may be provided in a separate user interface screen or provided in another portion of the fifth user interface screen which the notebook application 3100 is configured to generate in response to the selection of one of the user interface elements in the key topics section 4514.

For example, the second portion 4520 corresponds to a source content section (e.g., a context window) which includes information 4522 from at least a portion of an item of content from the source content. The notebook application 3100 may be configured to reproduce at least a portion of an item of content from the source content in the second portion 4520. In some implementations, the content in the source content section may correspond to a portion of an item of content which was relied upon for generating the summary section 4512.

For example, the third portion 4530 corresponds to a notes section (e.g., a scratchpad) which can include one or more notes that may be generated via various methods as described herein (e.g., automatically generated by the notebook application 3100, manually entered by a user, automatically generated by the notebook application 3100 in response to the selection of a user interface element which corresponds to an action to be performed, etc.).

For example, the fourth portion 4540 corresponds to a query section which can include one or more user interface elements for submitting or providing a query to the notebook application 3100 with respect to the source content. For example, the fourth portion 4540 includes a plurality of user interface elements 4542 which correspond to suggested questions or actions that are related to the source content. For example, the notebook application 3100 may be configured to generate the suggested questions or actions based on information included in the source content. For example, the notebook application 3100 may be configured to generate the suggested questions or actions based additionally on dialogue history (e.g., prior questions or queries), user data (e.g., preferences of the user, user attributes, etc.), and other contextual information. The fourth portion 4540 may further include a text entry box 4544 by which a user can provide an input (e.g., via a keyboard, via a voice input, etc.) to query the notebook application 3100. The fourth portion 4540 may further include a user interface element 4546 which indicates the number of items of content which comprise the source content. For example, in FIG. 4E, user interface element 4546 indicates three sources were relied upon by the notebook application 3100 to generate the summary section 4512.

Referring to FIG. 4F, an example user interface screen illustrates an input question and output response relating to the source content. For example, in FIG. 4F the notebook application 3100 is further configured to present for display a sixth user interface screen 4600 in response to receiving a query (e.g., a text query input via the text entry box 4544 of FIG. 4E). For example, sixth user interface screen 4600 includes a first portion 4610 which corresponds to a dialogue section, a second portion 4620 which corresponds to a sources section, and a third portion 430 which corresponds to a notes section (e.g., a scratchpad).

For example, the first portion 4610 includes a prompt area 4612 that corresponds to the text query and a response area 4614 that corresponds to the response to the text query. In some implementations, the notebook application 3100 is configured to generate the response by implementing one or more machine-learned models in response to receiving the text query as an input and with reference to the source content 3400. For example, if a user inputs a question (e.g., “How did the Cold War affect American foreign policy?) via the text entry box 4544 as described with respect to FIG. 4E, the notebook application 3100 may be configured to provide the sixth user interface screen 4600 and to generate a response as indicated in the response area 4614. As indicated in the response area 4614, the number of references (items of source content) relied upon by the one or more machine-learned models to generate the response may be indicated by a first user interface element 4616. In the example of FIG. 4F, three references were used to generate the response. The response area 4614 further includes a selectable second user interface element 4618 that, when selected, causes the response to be saved as a note to the third portion 4630 which corresponds to the notes section (e.g., a scratchpad) which can include one or more notes that may be generated via various methods as described herein (e.g., automatically generated by the notebook application 3100 in response to the selection of second user interface element 4618, etc.).

In some implementations, one or more portions of the response area may include information which is selectable that, when selected, can cause additional information to be displayed relating to the selected information. For example, in FIG. 4F the text “policy of containment” may be highlighted, bolded, underlined, or be displayed in some visually distinct manner to indicate that the text is selectable (e.g., a clickable chip) and additional information relating to the text is available. The notebook application 3100 may be configured to provide the additional information (e.g., by implementing one or more machine-learned models based on the selected source content) to provide additional information relating to the text, in response to the selection of the text.

The second portion 4620 may correspond to a source section and include the items of content 4622 which comprise the source content. In some implementations, the items of content 4622 may correspond to items of content which are relied upon by the one or more machine-learned models for generating the response. In some implementations, the notebook application 3100 may be configured to dynamically modify or re-generate a response in the response area 4614, in response to receiving an additional item of content to be added as source content via the user interface element 4624. In addition, or alternatively, in some implementations, the notebook application 3100 may be configured to dynamically modify or re-generate a response in the response area 4614, in response to receiving a deselection of an item of content from the list of items of content in the second portion 4620 via the user interface element 4626 (e.g., by unchecking the checkbox for one or more of the items of content in the second portion 4620).

Referring to FIG. 4G, an example user interface screen includes an example notes section (scratchpad) for a project, according to examples of the disclosure. For example, in FIG. 4G the notebook application 3100 is further configured to present for display a seventh user interface screen 4700 in response to receiving a selection of the second user interface element 4618 (e.g., as shown in FIG. 4F) that, when selected, causes the response to be saved as a note 4712 to the third portion 4710 which corresponds to the notes section (e.g., a scratchpad) which can include one or more notes that may be generated via various methods as described herein (e.g., automatically generated by the notebook application 3100 in response to the selection of second user interface element 4618, etc.). In FIG. 4G, user interface element 4714 indicates the number of items of content the one or more machine-learned models relied upon to generate the response for note 4712. Further, user interface element 4714 may be configured to be selectable such that in response to user interface element 4714 being selected, a list of the items of content (citations) from the source content used for generating the response can be provided for display.

Referring to FIG. 4H, an example user interface screen includes a notes section (scratchpad) for a project, according to examples of the disclosure. For example, in FIG. 4H the notebook application 3100 is further configured to present for display an eighth user interface screen 4800 in response to receiving a selection of an item 4816 of content from a list 4814 of items of content (citations) from the source content used by the one or more machine-learned models for generating the response saved in the note 4812 which is provided for display in the first portion 4810. The eighth user interface screen 4800 further includes a second portion 4820 which corresponds to a sources section. In FIG. 4H, the notebook application 3100 is configured to provide for display in the second portion 4820 information 4822 relating to the selected item 4816, in response to receiving the selection of the item 4816 of content from the list 4814 of items of content (citations) from the source content used by the one or more machine-learned models for generating the response saved in the note 4812.

In some implementations the information 4822 may include information from the item 4816 of content that was used to generate the response. For example, the notebook application 3100 may be configured to reference metadata associated with the response to refer back to the information 4822. The metadata may indicate a location of information from an item of content used to generate the response. Further, the information 4822 may correspond to or include a particular passage that was relied upon from the item of content for generating the response. For example, the notebook application 3100 may be configured to cause the particular passage to be displayed in the second portion 4820 in a visually distinctive manner (e.g., in a highlighted manner, a bold manner, an enlarged font size, an underlined manner, an italicized manner, etc.). For example, the notebook application 3100 may be configured to cause additional passages which appear before and/or after the particular passage to be displayed in the second portion 4820. This additional information may provide further context for the user regarding the information that was relied upon for generating the response. For example, the notebook application 3100 may be configured to mark particular items of content relied upon for generating the response in the note 4812 as well as mark particular passages from the particular items of content relied upon for generating the response in the note 4812. Therefore, a user can easily and visually discern where support for a response can be found in an item of content.

In some implementations, the information 4822 from the selected item 4816 of content that was used to generate the response may be truncated or shown in its entirety. For example, when the information 4822 is less than a threshold value, the entire text from the selected item 4816 of content can be shown in the second portion 4820 and can be used by the one or more machine-learned models for generating a response (e.g., to a text query). For example, when the information 4822 is more than the threshold value, the notebook application 3100 may be configured to implement a semantic retrieval method to determine particular passages from the entirety of the selected item 4816 of content which are relevant to a user query (e.g., a text query). In this example, the relevant passages (rather than the entirety of the information from the item of content) is relied upon by the one or more machine-learned models for generating a response to the user query (e.g., the text query).

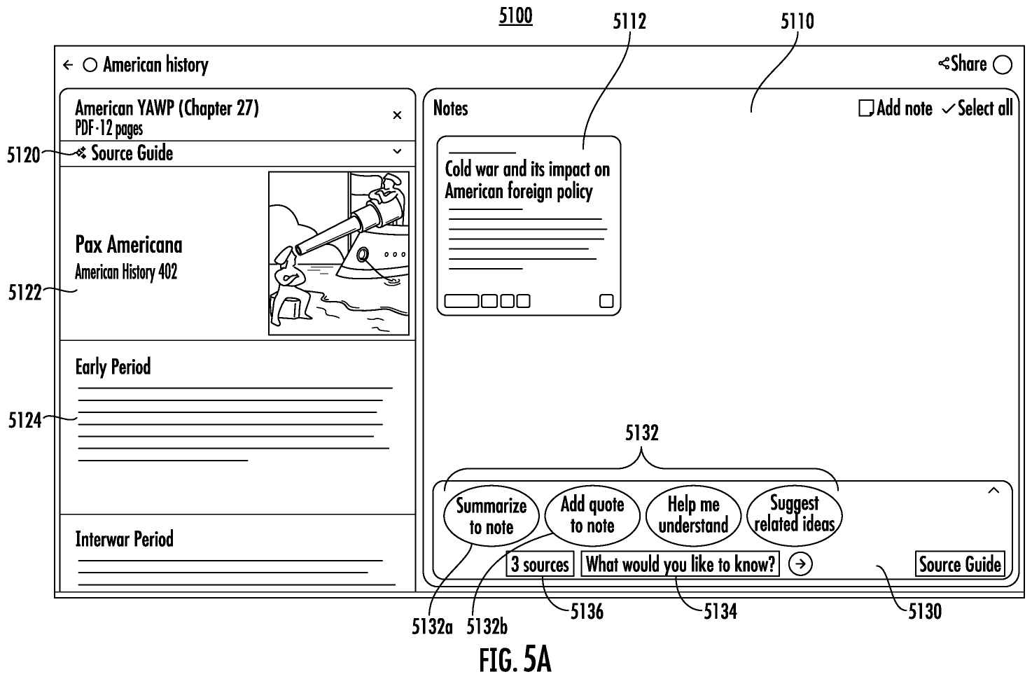

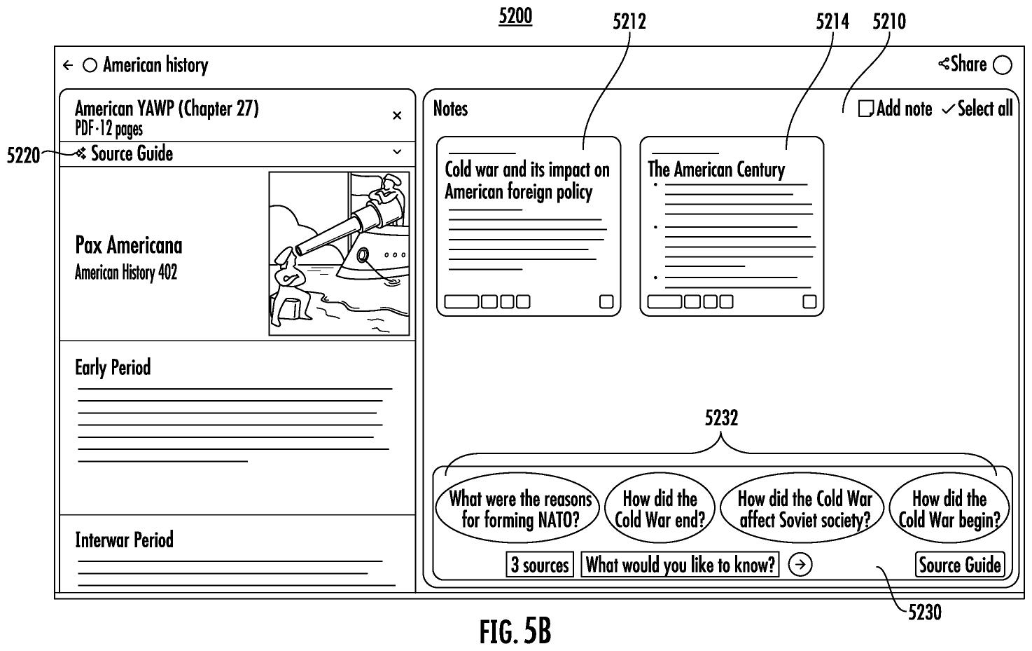

Examples of the disclosure are directed to further user-facing aspects by which a user can manage content, organize content, create content, etc., via a notebook application which is configured to implement one or more machine-learned models with respect to source content selected by the user. For example, FIGS. 5A through 5B illustrate examples of actions which can be implemented for a project in which a note is generated via one or more machine-learned models based on source content selected by a user, according to one or more example embodiments of the disclosure.

For example, FIG. 5A illustrates a first user interface screen of a notebook application, according to one or more example embodiments of the disclosure. For example, in FIG. 5A the first user interface screen 5100 includes a first portion 5110, a second portion 5120, and a third portion 5130. First portion 5110 corresponds to a notes section (e.g., a scratchpad) which can include one or more notes 5112 that may be generated via various methods as described herein (e.g., automatically generated by the notebook application 3100, manually entered by a user, automatically generated by the notebook application 3100 in response to the selection of a user interface element which corresponds to an action to be performed, etc.).

Second portion 5120 corresponds to a source content section (e.g., a source guide or context window) which can include one or more sources 5122 (e.g., items of content which comprises the source content 3400 relied upon by the one or more machine-learned models for generating the information included in the one or more notes 5112). In some implementations, the notebook application 3100 may be configured to generate a note which is saved to the first portion 5110 as a note based on a selection of at least a portion of the information from an item of content which is provided in the second portion 5120. For example, FIG. 5A illustrates selected text 5124 (e.g., highlighted text) that has been selected by a user.

For example, the third portion 5130 corresponds to a query section which can include one or more user interface elements for submitting or providing a query to the notebook application 3100 with respect to the source content. For example, the third portion 5130 includes a plurality of user interface elements 5132 which correspond to suggested questions or actions that are related to the source content. For example, the notebook application 3100 may be configured to generate the suggested questions or actions based on information included in the source content and/or based on the information displayed in the second portion 5120. The third portion 5130 may further include a text entry box 5134 by which a user can provide an input (e.g., via a keyboard, via a voice input, etc.) to query the notebook application 3100. The third portion 5130 may further include a user interface element 5136 which indicates the number of items of content which comprise the source content. For example, in FIG. 5A, user interface element 5136 indicates three sources were relied upon by the notebook application 3100 to generate the one or more notes 5112.

In some implementations, the plurality of user interface elements 5132 may be configured to dynamically change based on actions with respect to the first user interface screen 5100. For example, the notebook application 3100 may be configured to dynamically change, modify, delete, or add user interface elements in the third portion 5130 based on an action with respect to the source content (e.g., with respect to items of content provided for display in the second portion 5120). In FIG. 5A, the notebook application 3100 may be configured to dynamically change user interface elements in the third portion 5130 based on (in response to) the selection of text from one or more sources 5122 (e.g., the selected text 5124). For example, as indicated in FIG. 5A the actions may include summarizing the selected text to a note, adding a quote to a note, requesting additional information regarding the selected text 5124, or suggest related ideas. For example, the notebook application 3100 may be configured to generate a note summarizing the selected text in response to receiving a selection of user interface element 5132a which corresponds to the action of summarizing the selected text to a note. For example, the notebook application 3100 may be configured to add content to an existing note corresponding to the selected text in response to receiving a selection of user interface element 5132b which corresponds to the action of adding a quote to a note.

For example, FIG. 5B illustrates a second user interface screen of a notebook application, according to one or more example embodiments of the disclosure. For example, in FIG. 5B second user interface screen 5200 includes a first portion 5210, a second portion 5220, and a third portion 5230, each of which may correspond to the first portion 5110, second portion 5120, and third portion 5130 of FIG. 5A.

As described with respect to FIG. 5A, the notebook application 3100 may be configured to generate a note summarizing the selected text in response to receiving a selection of user interface element 5132a which corresponds to the action of summarizing the selected text to a note. FIG. 5B illustrates the generated note 5214 which has been saved to the first portion 5210 which includes one or more notes 5212. Further, in some implementations after the generated note 5214 is saved to the first portion 5210, the plurality of user interface elements 5132 from FIG. 5A may be configured to dynamically change back to a previous state to the plurality of user interface elements 5232 shown in FIG. 5B.

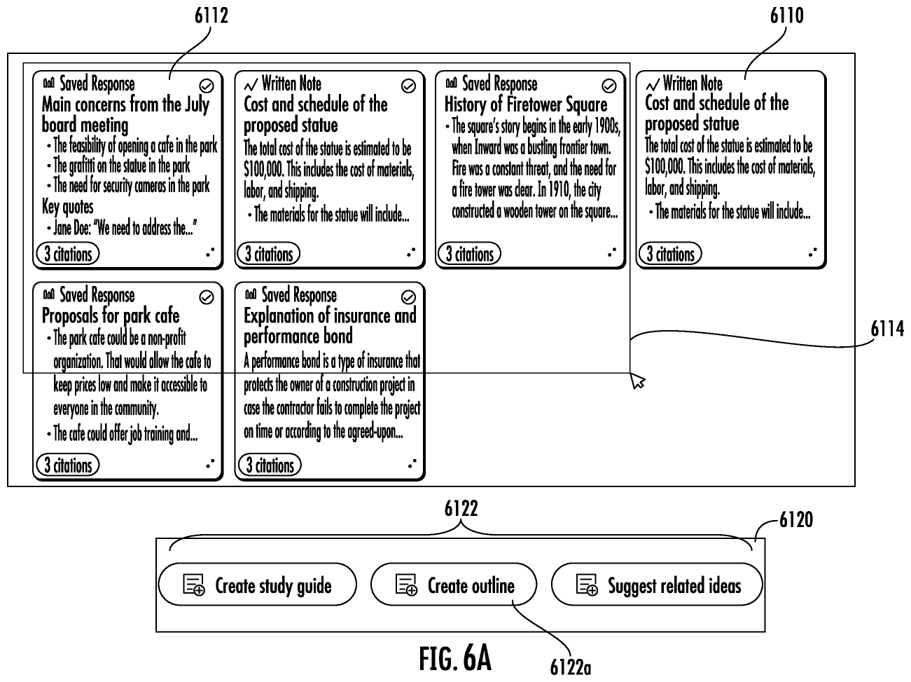

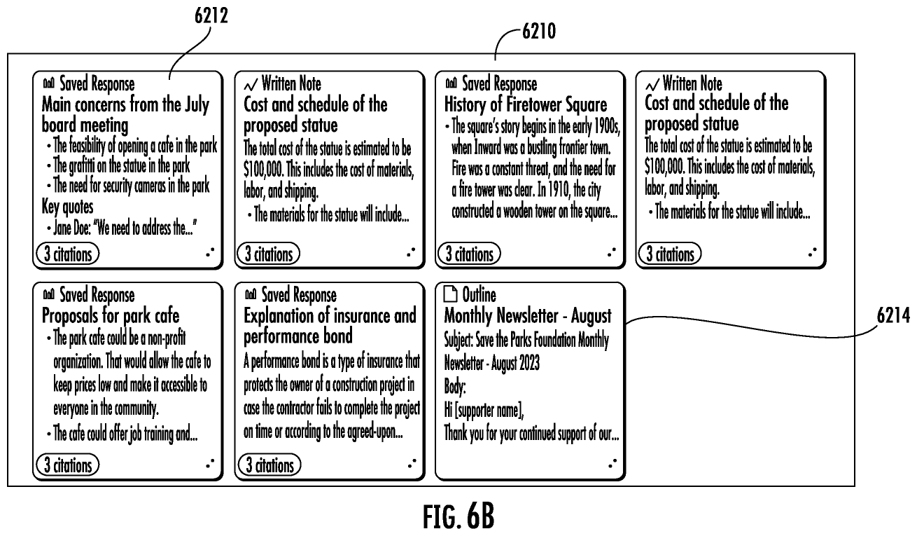

Examples of the disclosure are directed to further user-facing aspects by which a user can manage content, organize content, create content, etc., via a notebook application which is configured to implement one or more machine-learned models with respect to source content selected by the user. For example, FIGS. 6A through 6B illustrate examples of actions which can be implemented for a project in which a note is generated via one or more machine-learned models based on source content selected by a user, according to one or more example embodiments of the disclosure.

For example, FIG. 6A illustrates a portion of a first user interface screen of a notebook application, according to one or more example embodiments of the disclosure. For example, in FIG. 6A a first portion 6110 and a second portion 6120 of a user interface screen are shown. First portion 6110 corresponds to a notes section (e.g., a scratchpad) which can include a plurality of notes that may have been generated via various methods as described herein (e.g., automatically generated by the notebook application 3100, manually entered by a user, automatically generated by the notebook application 3100 in response to the selection of a user interface element which corresponds to an action to be performed, etc.). For example, the first portion 6110 may indicate how a particular note is created (e.g., as a saved response, as written note which is written by a user, as a document generated from other notes, etc.).

For example, the second portion 6120 corresponds to a query section which can include one or more user interface elements for submitting or providing a query to the notebook application 3100 with respect to the source content or with respect to the plurality of notes. For example, the second portion 6120 includes a plurality of user interface elements 6122 which correspond to suggested questions or actions that are related to the source content or plurality of notes. For example, the notebook application 3100 may be configured to generate the suggested questions or actions based on information included in the source content and/or based on the information displayed in the first portion 6110. The second portion 6120 may further include a text entry box by which a user can provide an input (e.g., via a keyboard, via a voice input, etc.) to query the notebook application 3100, a user interface element which indicates the number of items of content which comprise the source content, etc.

In the example of FIG. 6A, the notebook application 3100 may be configured to dynamically change user interface elements in the second portion 6120 based on (in response to) the selection of one or more notes 6112 from among the plurality of notes provided in the first portion 6110. For example, as indicated in FIG. 6A one or more notes may be selected via a user input (e.g., via a drag input, via selecting checkboxes, etc.) and in response to the selection of the one or more notes, the actions may include actions for creating content (e.g., creating a study guide, creating an outline, creating a spreadsheet, creating a presentation, etc.), suggesting related ideas, etc., based on the selected notes 6114. For example, the notebook application 3100 may be configured to generate a note which corresponds to an outline of the content from the selected notes 6114, in response to receiving a selection of user interface element 6122a which corresponds to the action of creating an outline and saving the outline to a note. For example, the notebook application 3100 may be configured to implement one or more machine-learned models to generate the note which corresponds to the selected notes 6114, in response to receiving a selection of a user interface element which corresponds to an action of creating content with respect to the selected one or more notes and saving the content as a note.

For example, FIG. 6B illustrates a portion of a second user interface screen of a notebook application, according to one or more example embodiments of the disclosure. For example, in FIG. 6B the first portion 6210 may correspond to the first portion 6110 of FIG. 6A.

As described with respect to FIG. 6A, the notebook application 3100 may be configured to generate a note based on one or more selected notes, by implementing one or more machine-learned models, where the selected notes may correspond to source content (e.g., source content selected by a user and used as an input for generating the note). For example, the generated note may summarize or outline the notes which have been selected as described with respect to FIG. 6A. The notebook application 3100 may be configured to generate the generated note 6214 based on the selected notes 6114, by implementing one or more machine-learned models, where the selected notes 6114 may correspond to source content (e.g., source content selected by a user and used as an input for generating the note), and in response to receiving a selection of a user interface element (e.g., user interface element 6122a) which corresponds to an action of summarizing the selected notes 6114 to the generated note 6214. FIG. 6B illustrates the generated note 6214 which has been saved to the first portion 6210 which includes one or more other notes 6212. Further, in some implementations after the generated note 6214 is saved to the first portion 6210, the plurality of user interface elements 6122 from FIG. 6A may be configured to dynamically change back to a previous state.

In some implementations, the notebook application 3100 may be configured to enable a generated note 6214 to be exported to other applications via selection of a user interface element to send the document to another application (e.g., a word processing application, a presentation application, a spreadsheet application, a social media application, etc.). In some implementations, the notebook application 3100 may be configured to enable a generated note 6214 and/or items of content (e.g., source content 3400) to be shared with other users via selection of a user interface element to share the document and/or source content with another user.

According to examples of the disclosure, the notebook application 3100 may be configured to generate an output (e.g., an outline, a report, a summary, etc.) via one or more machine-learned models, based on source content provided to the notebook application (e.g., by the user). The notebook application 3100 may be configured to allow a user to create various projects to complete various tasks. Each project may be configured to act in a manner similar to a folder by which a user can store various information to each project. In some implementations, an individual scratchpad may correspond to or be dedicated to a particular project. In some implementations, the notebook application 3100 may be configured to receive the source content as specified by the user. The notebook application 3100 may be configured to add, delete, or modify projects according to an input received from a user. Each project may be provided a default name, a name provided by the user, or a name generated by the notebook application 3100 (e.g., via one or more machine-learned models) based on the information stored in the project (e.g., based on the source content).

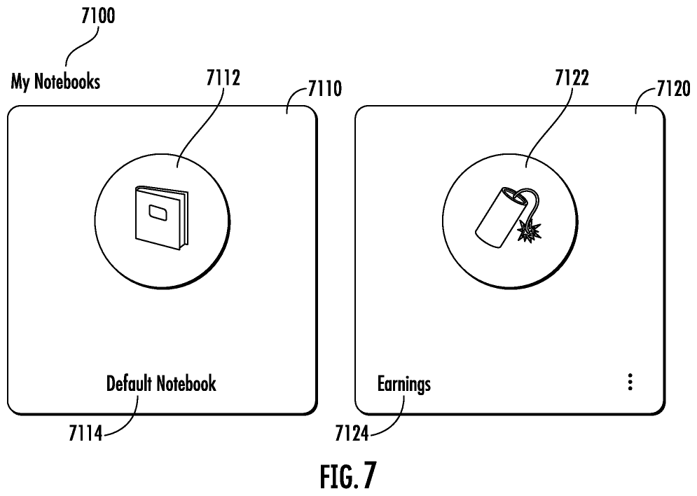

Examples of the disclosure are directed to further user-facing aspects by which a user can manage content, organize content, create content, etc., via a notebook application which is configured to implement one or more machine-learned models with respect to source content selected by the user. For example, FIG. 7 illustrates examples of notebooks or projects which can be represented in a particular manner so that a user can readily understand the contents contained within the notebook or project.

In some implementations, in response to source content being provided to the notebook application 3100, the notebook application 3100 may be configured to automatically generate (e.g., using one or more machine-learned models, one or more generative machine-learned models, semantic retrieval technologies, etc.), a graphical image (e.g., an emoji, an icon, etc.) or graphical animation which corresponds to or represents the source content. In some implementations, the graphical image or graphical animation may be overlaid on a folder which is provided as a user interface element that, when selected, causes the folder to open and display the contents of the folder to the user. In addition, or alternatively, in some implementations, in response to the source content being provided to the notebook application 3100, the notebook application 3100 may be configured to automatically generate (e.g., using one or more machine-learned models, one or more generative machine-learned models, semantic retrieval technologies, etc.), a textual description (name) which corresponds to or represents the source content. The textual description may be overlaid on the folder which is provided as a user interface element that, when selected, causes the folder to open and display the contents of the folder to the user.

Referring to FIG. 7, the notebook application 3100 may have a user-specific section 7100 which stores various projects in particular folders. For example, a first folder 7110 (e.g., default folder) may be represented by a default image 7112 and have a generic name 7114 (e.g., “Default Notebook”). For example, a second folder 7120 may be represented by a graphical image 7122 and have a textual description 7124 (e.g., “Earnings”) which is machine-learned generated and represents or corresponds to content included in the second folder 7120. For example, in response to source content being provided to the notebook application 3100, the notebook application 3100 may be configured to automatically generate (e.g., using one or more machine-learned models, one or more generative machine-learned models, semantic retrieval technologies, etc.), the graphical image 7122 which may correspond to an emoji, an icon, etc., which corresponds to or represents the source content. In some implementations, the graphical image 7122 may be overlaid on the second folder 7120 which is provided as a user interface element that, when selected, causes the second folder 7120 to open and display the contents of the second folder 7120 to the user. In addition, or alternatively, in some implementations, in response to the source content being provided to the notebook application 3100, the notebook application 3100 may be configured to automatically generate (e.g., using one or more machine-learned models, one or more generative machine-learned models, semantic retrieval technologies, etc.), the textual description 7124 (name) which corresponds to or represents the source content. The textual description 7124 may be overlaid on the second folder 7120 which is provided as a user interface element that, when selected, causes the second folder 7120 to open and display the contents of the second folder 7120 to the user.

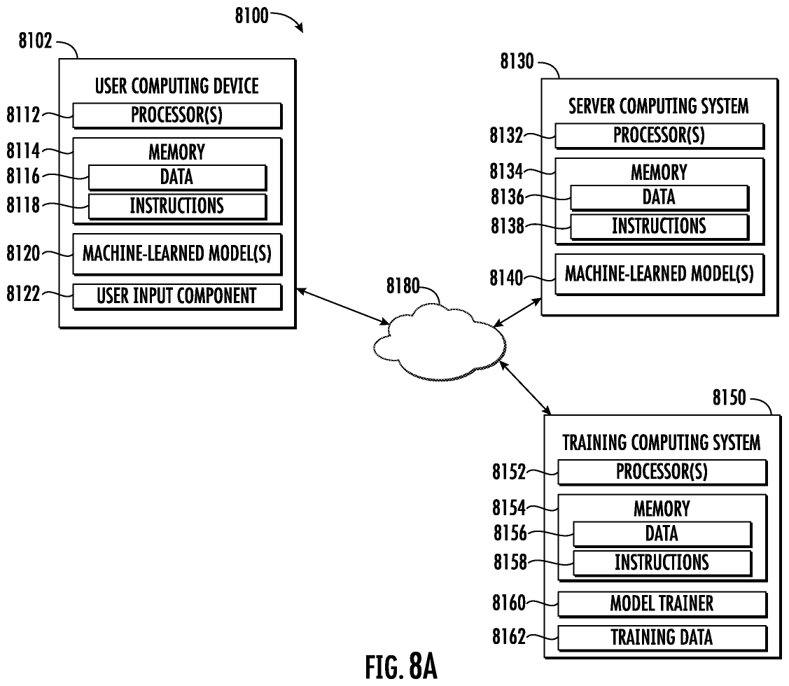

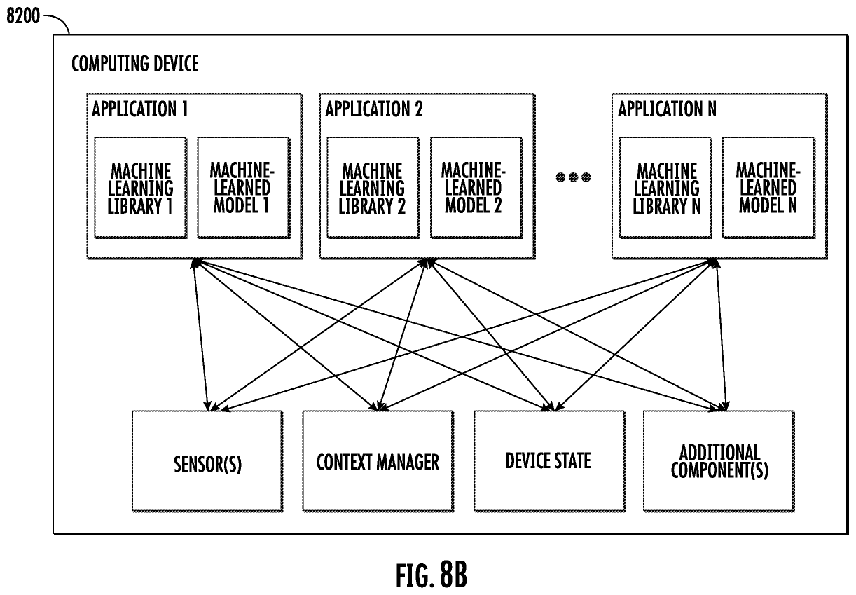

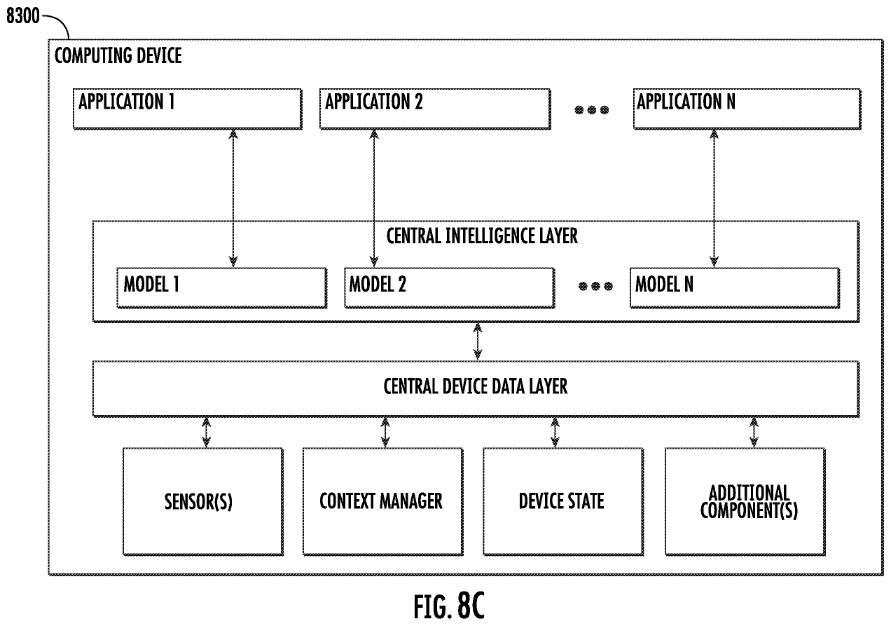

FIG. 8A depicts a block diagram of an example computing system for organizing, managing, and creating content by implementing one or more machine-learned models with respect to source content selected by a user, according to one or more example embodiments of the disclosure. The system 8100 includes a user computing device 8102, a server computing system 8130, and a training computing system 8150 that are communicatively coupled over a network 8180.

FIG. 8B depicts a block diagram of an example computing device for organizing, managing, and creating content by implementing one or more machine-learned models with respect to source content selected by a user, according to one or more example embodiments of the disclosure.

FIG. 8C depicts a block diagram of an example computing device for organizing, managing, and creating content by implementing one or more machine-learned models with respect to source content selected by a user, according to one or more example embodiments of the disclosure.

The user computing device 8102 (which may correspond to computing device 100) can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 8102 includes one or more processors 8112 and a memory 8114. The one or more processors 8112 can be any suitable processing device (e.g., a processor core, a microprocessor, an ASIC, an FPGA, a controller, a microcontroller, etc.) and can be one processor or a plurality of processors that are operatively connected. The memory 8114 can include one or more non-transitory computer-readable storage media, such as RAM, ROM, EEPROM, EPROM, flash memory devices, magnetic disks, etc., and combinations thereof. The memory 8114 can store data 8116 and instructions 8118 which are executed by the processor 8112 to cause the user computing device 8102 to perform operations.

In some implementations, the user computing device 8102 can store or include one or more machine-learned models 8120 (e.g., large language models, sequence processing models, generative machine-learned models, etc.). For example, the one or more machine-learned models 8120 can be or can otherwise include various machine-learned models such as neural networks (e.g., deep neural networks) or other types of machine-learned models, including non-linear models and/or linear models. Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models (e.g., transformer models). Example machine-learned models were described herein with reference to FIGS. 1A through 7.

In some implementations, the one or more machine-learned models 8120 can be received from the server computing system 8130 over network 8180, stored in the memory 8114, and then used or otherwise implemented by the one or more processors 8112. In some implementations, the user computing device 8102 can implement multiple parallel instances of a single machine-learned model (e.g., to perform parallel tasks across multiple instances of the machine-learned model). In some implementations, the task is a generative task and one or more machine-learned models may be implemented to output content (e.g., a response to a question, a summarization of various selected items of content, an outline of various selected notes, etc.) in view of various inputs (e.g., a query, conditioning parameters, etc.). More particularly, the machine-learned models disclosed herein (e.g., including large language models, sequence processing models, generative machine-learned models, etc.), may be implemented to perform various tasks related to an input query.

According to examples of the disclosure, a computing system may implement one or more sequence processing models 3120 as described herein to output values for the one or more conditions in response to or based on the query. The one or more sequence processing models 3120 may include one or more machine-learned models which are configured to process and analyze sequential data and to handle data that occurs in a specific order or sequence, including time series data, natural language text, or any other data with a temporal or sequential structure.

According to examples of the disclosure, a computing system may implement one or more large language models 3130 to determine a plurality of variables based on the query. For example, a large language model may include a Bidirectional Encoder Representations from Transformers (BERT) large language model. The large language model may be trained to understand and process natural language for example. The large language model may be configured to extract information from the input (query) to identify keywords, intents, and context within the input to determine a plurality of variables for generating content. The variables may include latent variables that represent an underlying structure of the language.

According to examples of the disclosure, a computing system may implement one or more generative machine-learned models 3140 to generate various content (e.g., for generating an outline, a summary, a response to a query, etc.) having values for one or more conditions. The one or more generative machine-learned models 3140 may include a deep neural network or a generative adversarial network (GAN) to generate the content with one or more features having values for one or more conditions associated with the features. For example, the one or more generative machine-learned models 3140 may include variational autoencoders, stable diffusion machine-learned models, visual transformers, neural radiance fields (NeRFs), etc., to generate the content.

Additionally, or alternatively, one or more machine-learned models 8140 can be included in or otherwise stored and implemented by the server computing system 8130 that communicates with the user computing device 8102 according to a client-server relationship. For example, the one or more machine-learned models 8140 can be implemented by the server computing system 8130 as a portion of a web service (e.g., a navigation service, a word processing service, an educational service, and the like). Thus, one or more machine-learned models 8120 can be stored and implemented at the user computing device 8102 and/or one or more machine-learned models 8140 can be stored and implemented at the server computing system 8130.

The user computing device 8102 can also include one or more user input components 8122 that receives user input. For example, the user input component 8122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other devices and methods by which a user can provide a user input.

The server computing system 8130 (which may correspond to server computing system 300) includes one or more processors 8132 and a memory 8134. The one or more processors 8132 can be any suitable processing device (e.g., a processor core, a microprocessor, an ASIC, an FPGA, a controller, a microcontroller, etc.) and can be one processor or a plurality of processors that are operatively connected. The memory 8134 can include one or more non-transitory computer-readable storage media, such as RAM, ROM, EEPROM, EPROM, flash memory devices, magnetic disks, etc., and combinations thereof. The memory 8134 can store data 8136 and instructions 8138 which are executed by the processor 8132 to cause the server computing system 8130 to perform operations.

In some implementations, the server computing system 8130 includes or is otherwise implemented by one or more server computing devices. In instances in which the server computing system 8130 includes a plurality of server computing devices, such server computing devices can operate according to sequential computing architectures, parallel computing architectures, or some combination thereof.

As described above, the server computing system 8130 can store or otherwise include one or more machine-learned models 8140. For example, the one or more machine-learned models 8140 can be or can otherwise include various machine-learned models. Example machine-learned models include neural networks or other multi-layer non-linear models. Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models (e.g., transformer models). Example machine-learned models were described herein with reference to FIGS. 1A through 7.

The user computing device 8102 and/or the server computing system 8130 can train the one or machine-learned models 8120 and/or 8140 via interaction with the training computing system 8150 that is communicatively coupled over the network 8180. The training computing system 8150 can be separate from the server computing system 8130 or can be a portion of the server computing system 8130.

The training computing system 8150 includes one or more processors 8152 and a memory 8154. The one or more processors 8152 can be any suitable processing device (e.g., a processor core, a microprocessor, an ASIC, an FPGA, a controller, a microcontroller, etc.) and can be one processor or a plurality of processors that are operatively connected. The memory 8154 can include one or more non-transitory computer-readable storage media, such as RAM, ROM, EEPROM, EPROM, flash memory devices, magnetic disks, etc., and combinations thereof. The memory 8154 can store data 8156 and instructions 8158 which are executed by the processor 8152 to cause the training computing system 8150 to perform operations. In some implementations, the training computing system 8150 includes or is otherwise implemented by one or more server computing devices.

The training computing system 8150 can include a model trainer 8160 that trains the one or more machine-learned models 8120 and/or 8140 stored at the user computing device 8102 and/or the server computing system 8130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 8160 can perform a number of generalization techniques (e.g., weight decays, dropouts, etc.) to improve the generalization capability of the models being trained.

In particular, the model trainer 8160 can train the one or more machine-learned models 8120 and/or 8140 based on a set of training data 8162. The training data 8162 can include, for example, various datasets which may be stored remotely or at the training computing system 8150. For example, in some implementations an example dataset utilized for training includes a large corpus of language training data that provides one or more large language models with the capability to perform multiple language tasks. For example, the one or more large language models can be trained to perform summarization tasks, conversational tasks, simplification tasks, oppositional viewpoint tasks, etc. In particular, the one or more large language models can be trained to process a variety of outputs to generate a language output. However, other datasets (e.g., of images) may be utilized (e.g., images obtained from external websites). In some implementations, the dataset may be confined to a particular genre or subject, particular kinds of content including imagery, videos, and text, particular styles of content including outlines, reports, presentations, spreadsheets, etc.), etc. In some implementations, the dataset may contain diverse subject matter.

In some implementations, if the user has provided consent, the training examples can be provided by the user computing device 8102. Thus, in such implementations, the one or more machine-learned models 8120 provided to the user computing device 8102 can be trained by the training computing system 8150 on user-specific data received from the user computing device 8102. In some instances, this process can be referred to as personalizing the model.

The model trainer 8160 includes computer logic utilized to provide desired functionality. The model trainer 8160 can be implemented in hardware, firmware, and/or software controlling a general purpose processor. For example, in some implementations, the model trainer 8160 includes program files stored on a storage device, loaded into a memory and executed by one or more processors. In other implementations, the model trainer 8160 includes one or more sets of computer-executable instructions that are stored in a tangible computer-readable storage medium such as RAM, hard disk, or optical or magnetic media.

The network 8180 can be any type of communications network, such as a local area network (e.g., intranet), wide area network (e.g., Internet), or some combination thereof and can include any number of wired or wireless links. In general, communication over the network 8180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

FIG. 8A illustrates an example computing system that can be used to implement aspects of the disclosure. Other computing systems can be used as well. For example, in some implementations, the user computing device 8102 can include the model trainer 8160 and the training data 8162. In such implementations, the one or more machine-learned models 8120 can be both trained and used locally at the user computing device 8102. In some of such implementations, the user computing device 8102 can implement the model trainer 8160 to personalize the one or more machine-learned models 8120 based on user-specific data.

FIG. 8B depicts a block diagram of an example computing device for organizing, managing, and creating content by implementing one or more machine-learned models with respect to source content selected by a user, according to one or more example embodiments of the disclosure. The computing device 8200 can be a user computing device or a server computing device.

The computing device 8200 includes a number of applications (e.g., applications 1 through N). Each application contains its own machine learning library and machine-learned model(s). For example, each application can include a machine-learned model. Example applications include a notebook application, a text messaging application, an email application, a dictation application, a virtual keyboard application, a browser application, a social media application, a map application, a navigation application, etc.

As illustrated in FIG. 8B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 8C depicts a block diagram of an example computing device for organizing, managing, and creating content by implementing one or more machine-learned models with respect to source content selected by a user, according to one or more example embodiments of the disclosure. The computing device 80 can be a user computing device or a server computing device.

The computing device 8300 includes a number of applications (e.g., applications 1 through N). Each application is in communication with a central intelligence layer. Example applications include a notebook application as described herein, a notebook application, a text messaging application, an email application, a dictation application, a virtual keyboard application, a browser application, a map application, a social media application, a navigation application, a social media application, etc. In some implementations, each application can communicate with the central intelligence layer (and model(s) stored therein) using an API (e.g., a common API across all applications).

The central intelligence layer includes a number of machine-learned models. For example, as illustrated in FIG. 8C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 8300.

The central intelligence layer can communicate with a central device data layer. The central device data layer can be a centralized repository of data for the computing device 8300. As illustrated in FIG. 8C, the central device data layer can communicate with a number of other components of the computing device, such as, for example, one or more sensors, a context manager, a device state component, and/or additional components. In some implementations, the central device data layer can communicate with each device component using an API (e.g., a private API).

To the extent alleged generic terms including “module”, and “unit,” and the like are used herein, these terms may refer to, but are not limited to, a software or hardware component or device, such as a Field Programmable Gate Array (FPGA) or Application Specific Integrated Circuit (ASIC), which performs certain tasks. A module or unit may be configured to reside on an addressable storage medium and configured to execute on one or more processors. Thus, a module or unit may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules/units may be combined into fewer components and modules/units or further separated into additional components and modules.

Aspects of the above-described example embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks, Blue-Ray disks, and DVDs; magneto-optical media such as optical discs; and other hardware devices that are specially configured to store and perform program instructions, such as semiconductor memory, read-only memory (ROM), random access memory (RAM), flash memory, USB memory, and the like. Examples of program instructions include both machine code, such as produced by a compiler, and files containing higher level code that may be executed by the computer using an interpreter. The program instructions may be executed by one or more processors. The described hardware devices may be configured to act as one or more software modules in order to perform the operations of the above-described embodiments, or vice versa. In addition, a non-transitory computer-readable storage medium may be distributed among computer systems connected through a network and computer-readable codes or program instructions may be stored and executed in a decentralized manner. In addition, the non-transitory computer-readable storage media may also be embodied in at least one application specific integrated circuit (ASIC) or Field Programmable Gate Array (FPGA).

Each block of the flowchart illustrations may represent a unit, module, segment, or portion of code, which comprises one or more executable instructions for implementing the specified logical function(s). It should also be noted that in some alternative implementations, the functions noted in the blocks may occur out of order. For example, two blocks shown in succession may in fact be executed substantially concurrently (simultaneously) or the blocks may sometimes be executed in the reverse order, depending upon the functionality involved.

While the disclosure has been described with respect to various example embodiments, each example is provided by way of explanation, not limitation of the disclosure. Those skilled in the art, upon attaining an understanding of the foregoing, can readily produce alterations to, variations of, and equivalents to such embodiments. Accordingly, the disclosure does not preclude inclusion of such modifications, variations and/or additions to the disclosed subject matter as would be readily apparent to one of ordinary skill in the art. For example, features illustrated or described as part of one embodiment can be used with another embodiment to yield a still further embodiment. Thus, it is intended that the disclosure covers such alterations, variations, and equivalents.

What is claimed is:

1. A computing device for generating content, comprising:
one or more memories configured to store instructions; and
one or more processors configured to execute the instructions to perform operations, the operations comprising:
providing, in response to a selection of a plurality of items of content, a user interface including a first portion and a second portion, the first portion including a summary description generated via one or more machine-learned models based on the plurality of items of content and the second portion including a plurality of user interface elements configured to perform an operation with respect to at least one of the summary description or the plurality of items of content.

2. The computing device of claim 1, wherein the operations further comprise:
receiving a selection of the plurality of items of content; and
implementing the one or more machine-learned models to generate the summary description based on the plurality of items of content.

3. The computing device of claim 1, wherein
the plurality of user interface elements include a first user interface element comprising a suggested query, and
the operations further comprise:
receiving a selection of the first user interface element; and
implementing the one or more machine-learned models to generate a response to the suggested query based on at least one of the summary description or the plurality of items of content.

4. The computing device of claim 3, wherein the operations further comprise providing the user interface a third portion to provide for display a dialogue including the suggested query and the response.

5. The computing device of claim 4, wherein the third portion includes a citation user interface element which indicates a number of items of content from among the plurality of items of content referenced by the one or more machine-learned models to generate the response.

6. The computing device of claim 5, wherein the operations further comprise:
in response to receiving a selection of the citation user interface element, providing, for display in a fourth portion of the user interface, content from one or more items of content from among the plurality of items of content used to generate the response.

7. The computing device of claim 4, wherein the third portion includes a note generation user interface element, and
the operations further comprise:
in response to receiving a selection of the note generation user interface element, generating a note which includes content from the suggested query and the response, and
storing the note.

8. The computing device of claim 1, wherein
the plurality of user interface elements include a first user interface element configured to generate a note, and
the operations further comprise:
providing the user interface a third portion which includes content from one or more items of content from among the plurality of items of content;
receiving a selection of a portion of the content from the one or more items of content from among the plurality of items of content;
receiving a selection of the first user interface element; and
in response to receiving the selection of the portion of the content and the first user interface element, generating, via the one or more machine-learned models based on the portion of the content, the note which includes a summary of the portion of the content.

9. The computing device of claim 1, wherein
the plurality of user interface elements include a first user interface element configured to add content to an existing note, and
the operations further comprise:
providing the user interface a third portion which includes content from one or more items of content from among the plurality of items of content;
receiving a selection of a portion of the content from the one or more items of content from among the plurality of items of content;
receiving a selection of the first user interface element; and
in response to receiving the selection of the portion of the content and the first user interface element, adding the portion of the content to the existing note.

10. The computing device of claim 1, wherein
the first portion further includes at least one key topic user interface element comprising at least one key topic relating to the summary description of the plurality of items of content, and
the operations further comprise receiving a selection of the at least one key topic user interface element; and
implementing the one or more machine-learned models to generate an output relating to the at least one key topic based on at least one of the summary description or the plurality of items of content.

11. The computing device of claim 10, wherein the operations further comprise providing the user interface a third portion to provide for display a dialogue including the key topic and the output relating to the at least one key topic.

12. The computing device of claim 1, wherein the operations further comprise:
providing the user interface a third portion to provide for display at least one note generated via the one or more machine-learned models based on the plurality of items of content.

13. The computing device of claim 12, wherein
the third portion includes a citation user interface element which indicates a number of items of content from among the plurality of items of content referenced by the one or more machine-learned models to generate the at least one note.

14. The computing device of claim 13, wherein the operations further comprise:
in response to receiving a selection of the citation user interface element, providing, for display in a fourth portion of the user interface, content from one or more items of content from among the plurality of items of content used to generate the note.

15. The computing device of claim 14, wherein the operations further comprise:
in response to receiving the selection of the citation user interface element, providing, for display in the fourth portion of the user interface, contextual content about the content from the one or more items of content from among the plurality of items of content used to generate the note.

16. The computing device of claim 12, wherein the plurality of user interface elements include a first user interface element configured to generate new content based on one or more notes, and
the operations further comprise:
providing the user interface a third portion to provide for display a plurality of notes generated via the one or more machine-learned models based on the plurality of items of content;
receiving a selection of the plurality of notes;
receiving a selection of the first user interface element; and
in response to receiving the selection of the plurality of notes and the first user interface element, generate the new content based on the plurality of notes.

17. The computing device of claim 1, wherein the operations further comprise:
generating, via the one or more machine-learned models, a graphical image representing the plurality of items of content; and
providing a folder including the graphical image, the folder storing the plurality of items of content and a project file including the summary description.

18. The computing device of claim 1, wherein
the second portion includes a text entry box to receive a query from a user, and
the operations further comprise:
implementing the one or more machine-learned models to generate a response to the query based on at least one of the summary description or the plurality of items of content.

19. A computing device for generating content, comprising:
one or more memories configured to store instructions; and
one or more processors configured to execute the instructions to perform operations, the operations comprising:
receiving an input to create a notebook;
receiving a selection of a plurality of items of content to add to the notebook;
in response to receiving the selection of the plurality of items of content, implementing one or more machine-learned models to generate a summary description based on the plurality of items of content and at least one of a key topic user interface element indicative of a topic of the plurality of items of content or a selectable user interface element indicative of a query relating to the plurality of items of content; and
providing a user interface including a first portion and a second portion, the first portion including the summary description and the second portion including the selectable user interface element.

20. A computer-implemented method, comprising:
receiving, by a computing system, an input to create a notebook;
receiving, by the computing system, a selection of a plurality of items of content to add to the notebook;
in response to receiving the selection of the plurality of items of content, implementing, by the computing system, one or more machine-learned models to generate a summary description based on the plurality of items of content and at least one of a key topic user interface element indicative of a topic of the plurality of items of content or a selectable user interface element indicative of a query relating to the plurality of items of content; and
providing, by the computing system, a user interface including a first portion and a second portion, the first portion including the summary description and the second portion including the selectable user interface element.
